(19) United States
(12) Patent Application Publication
(10) Pub. No.: US 2011/0173138 A1
(43) Pub. Date: Jul. 14, 2011

(54) EQUITY BASED INCENTIVE COMPENSATION PLAN

(76) Inventor: Raymond B. Ryan, Darien, CT (US)

(21) Appl. No.: 13/069,245

(22) Filed: Mar. 22, 2011

Related U.S. Application Data
(63) Continuation-in-part of application No. 12/611,671, filed on Nov. 3, 2009.
Application No. 12/611,671 is a continuation-in-part of application No. 10/816,014, filed on Apr. 1, 2004, now Pat. No. 7,613,642.
(60) Provisional application No. 60/459,718, filed on Apr. 1, 2003.

(51) Int. Cl. G06Q 40/00

(52) U.S. Cl. 705/36 T; 705/35; 705/36 R

(57) ABSTRACT

An equity based incentive compensation plan is established by acquiring shares of an equity security by grant and by purchase using funds loaned by a third party. The risk of the loan may be abated using various strategies including employing a forward contract between the lender and a third party. The amount of the loan repayment amount may reflect the cost to the lender or entering into the forward contract with the third party. The computer system of the invention manages plans including calculating the ratio of a plan's loan repayment amount(s) to the value of the plan's shares that are collateral of the loan.

### CROSS-REFERENCE TO RELATED APPLICATIONS

This application is a continuation-in-part of application Ser. No. 12/611,671 filed on Nov. 3, 2009 which is a continuation-in-part of application Ser. No. 10/816,014 filed on Apr. 1, 2004, now U.S. Pat. No. 7,613,642, which claims benefit to provisional application 60/459,718 filed on Apr. 1, 2003, all applications of which are incorporated by reference herein in their entirety.

### BACKGROUND

During the bull market of the 1990's and through 2000, employer stock options became the largest component of the compensation for senior executives at public corporations. Also, the availability of stock options became more widespread. In 1992, there were about 1 million employees holding stock option grants. By 2002, that number had grown to almost 10 million employees. Technology companies particularly embraced stock options. In 2000, CISCO employees exercised options for a total gain of $2.5 billion and Enron employees realized $1.5 billion in stock option gains. In Enron's case, the top 200 of 25,000 employees accounted for $1.2 billion or 80% of the total gain.

A stock option is a right to purchase shares of stock at a set price during some period of time. Most often, the option price is the market price at date of grant and the exercise period is a five to ten year window. Most stock option plans discriminate for the benefit of senior management of a corporation. As such, these plans are “nonqualified” for income tax purposes. The Internal Revenue Code has special rules for Incentive Stock Option and Employee Stock Purchase Plan Option plans. While providing opportunities to tax certain option gains as capital gains, generally these plans require that they be non-discriminatory. As a result, the vast majority of stock option grants and exercises are nonqualified plans. As such, the increase in the share value over the option price in the non-qualified plan is ordinary income to the executive at the date of exercise. Also, the employer receives an ordinary income tax deduction equal to the same amount as the employees' income at the date of exercise.

Generally Accepted Accounting Principles (“GAAP”) accounting rules differ from tax rules for stock options. Prior to 2003, GAAP permitted the corporate expense of a stock option grant to be the difference between the current market price and the option price at the date of grant. That difference is normally zero. This was a long standing GAAP rule. Today, the Financial Accounting Standards Board (“FASB”) requires corporations to also disclose the estimated fair value of stock option grants to an employee as determined by a sophisticated financial model (FASB Statements No. 123 and No. 148 specify the Black-Scholes model as one valid model).

At the end of 2003, FASB issued FASB Statement No. 123 which requires some form of Black-Scholes current value expense accounting. In anticipation of this accounting change, during 2003 and 2004 a number of large corporations elected to adopt FASB Statement No. 123 and No. 148 accrual accounting for computing the GAAP cost of stock options. In addition, some companies significantly revised or even eliminated their stock option plans (e.g., Microsoft and IBM). In the past, absent the Black-Scholes model to calculate a present value cost of stock option grants, stock options have had little or no effect on employer earnings.

On the other hand, the exercise of stock options by employees does trigger a significant tax deduction without a book earnings charge or penalty. For example, in 2000, Enron reported GAAP earnings of about $1 billion. Because of their $1.5 billion of stock option exercise income tax deduction and other tax shelter items, Enron paid only $63 million in income taxes. That was the first tax paid in five years by Enron despite an average book income of $650 million per annum during the same five year period.

Because of Enron, a number of other high profile corporate failures, and well publicized incidents of executive white collar crime, there has been a widespread belief in academia and in Congress that the executive malfeasance during the between 1995 and 2005 arose indirectly because of the extraordinary tax benefits of stock options to corporations. GAAP provide no disincentive to counterbalance the opportunity for the privileged few in senior management to use larger and larger stock options to increase their pay.

Corporate book earnings were not affected by the grant or the exercise of stock options. The significant tax benefits to the corporation helped to justify the huge and near term wealth created by stock options for senior management. The only apparent consequence was dilution of existing shareholders. With share market value increases in the bull market years, dilution was masked and painless. For too many executives, managing reported income became more important than truly growing their business and earning real revenue—do whatever drives the share price up, became the mantra in the period. The consequences have brought scrutiny to the area of benefit plans.

### BRIEF SUMMARY

The present invention extends to methods, systems, and computer program products for creating and managing employer sponsored benefit plans granting share awards that are not tax qualified plans. These plans may or may not be subject to ERISA compliance without regard to their tax status. The present invention also facilitates the implementation of risk abatement strategies in conjunction with such plans.

In one embodiment, a value of an equity security of a company sponsoring an equity based incentive compensation plan for one or more employees of the company is received. The equity based incentive compensation plan comprises one or more employees (1) receiving an award grant of one or more shares of the security, or interests therein; and (2) purchasing one or more shares of the security with funds borrowed from a third party lender. A loan repayment amount, a loan duration, and a loan amount that the third party lender offers for one or more loans made to an employee, or for the benefit of an employee, to purchase the one or more shares of the security are also received. The loan collateral includes, in whole or in part, one or more awarded and purchased shares of the security in the equity based incentive compensation plan.

The loan repayment amount less the loan amount comprises interest which reflects the time value of money as well as one or more risk abatement strategies the third party lender may employ based on the lender's assessment of the risk relative to the collateral and the duration of the loan. The equity based incentive compensation plan is then established by the receipt of the one or more awarded shares and the purchase of the one or more shares using the loan amount to be held directly by or on behalf of the one or more employees.

In another embodiment, a value of an equity security of a company sponsoring an equity based incentive compensation plan for one or more employees of the company is received. The equity based incentive compensation plan comprises one or more employees (1) receiving an award grant of one or more shares of the security, or interests therein; and (2) purchasing one or more shares of the security with funds borrowed from a third party lender. A loan repayment amount, a loan duration, and a loan amount that the third party lender offers for one or more loans made to an employee, or for the benefit of an employee, to purchase the one or more shares of the security are also received. The loan collateral includes, in whole or in part, one or more awarded and purchased shares of the security in the equity based incentive compensation plan.

Next, the equity based incentive compensation plan is established by the receipt of the one or more awarded shares and the purchase of the one or more shares using the loan amount to be held directly by or in behalf of the one or more employees. Finally, the ratio of at least a portion of the loan repayment amount divided by the value of the collateralized shares is calculated, and one or more of the third party lender, the employer, or the employee is notified of the ratio.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a diagram of an exemplary computer system according to the present Invention, linked to a plan administrator's computer system which is linked to one or more of the following: a lender computer system, a plan sponsor (i.e. the employer computer system, a plan fiduciary computer system, a brokerage firm computer system, a plan participant (i.e. employee beneficiary) computer system, or an administrator computer system.

FIG. 2 is a block diagram presenting an overall view of a representative embodiment of the present invention.

FIG. 3A is a columnar depiction of information data fields collected, processed, stored and retrieved by computer system 100.

FIG. 3B is a columnar depiction of information data fields collected, processed, stored and retrieved by computer system 100.

FIG. 3C is a columnar depiction of information data fields collected, processed, stored and retrieved by computer system 100.

FIG. 3D is a columnar depiction of information data fields collected, processed, stored and retrieved by computer system 100.

FIG. 3E is a columnar depiction of information data fields collected, processed, stored and retrieved by computer system 100.

FIG. 4 is a block diagram of the periodic update processes of the present Invention.

FIG. 5A is a block diagram of the periodic loan monitoring process of the present Invention.

FIG. 5B is a block diagram of the periodic loan monitoring process of the present Invention.

FIG. 5C is a block diagram of the periodic loan monitoring process of the present Invention.

FIG. 6A is a block diagram of the periodic performance tracking and reporting process of the present Invention.

FIG. 6B is a block diagram of the periodic performance tracking and reporting process of the present Invention.

FIG. 6C is a block diagram of the periodic performance tracking and reporting process of the present Invention.

FIG. 6D is a block diagram of the periodic performance tracking and reporting process of the present Invention.

FIG. 6E is a block diagram of the periodic performance tracking and reporting process of the present Invention.

FIG. 6F is a block diagram of the periodic performance tracking and reporting process of the present Invention.

FIG. 6G is a block diagram of the periodic performance tracking and reporting process of the present Invention.

FIG. 6H is a block diagram of the periodic performance tracking and reporting process of the present Invention.

FIG. 6I is a block diagram of the periodic performance tracking and reporting process of the present Invention.

FIG. 6J is a block diagram of the periodic performance tracking and reporting process of the present Invention.

FIG. 6K is a block diagram of the periodic performance tracking and reporting process of the present Invention.

FIG. 7A is a block diagram of the illustration process of the present invention.

FIG. 7B is a block diagram of the illustration process of the present invention.

FIG. 7C is a block diagram of the illustration process of the present invention.

FIG. 7D is a block diagram of the illustration process of the present invention.

FIG. 8 is a flowchart of an exemplary method for establishing an equity based incentive compensation plan according to the alternative embodiment of the present invention.

FIG. 9A-B is a columnar depiction of information data fields collected, processed, stored and retrieved by computer system 100 in accordance with the alternative embodiment of the present invention.

### DETAILED DESCRIPTION

The present invention extends to methods, systems, and computer program products for creating and managing employer sponsored benefit plans granting share awards that are not tax qualified plans. These plans may or may not be subject to ERISA compliance without regard to their tax status. The present invention also facilitates the implementation of risk abatement strategies in conjunction with such plans.

In one embodiment, a value of an equity security of a company sponsoring an equity based incentive compensation plan for one or more employees of the company is received. The equity based incentive compensation plan comprises one or more employees (1) receiving an award grant of one or more shares of the security, or interests therein; and (2) purchasing one or more shares of the security with funds borrowed from a third party lender. A loan repayment amount, a loan duration, and a loan amount that the third party lender offers for one or more loans made to an employee, or for the benefit of an employee, to purchase the one or more shares of the security are also received. The loan collateral includes, in whole or in part, one or more awarded and purchased shares of the security in the equity based incentive compensation plan.

The loan repayment amount less the loan amount comprises interest which reflects the time value of money as well as one or more risk abatement strategies the third party lender may employ based on the lender's assessment of the risk relative to the collateral and the duration of the loan. The equity based incentive compensation plan is then established by the receipt of the one or more awarded shares and the purchase of the one or more shares using the loan amount to be held directly by or on behalf of the one or more employees.

In another embodiment, a value of an equity security of a company sponsoring an equity based incentive compensation plan for one or more employees of the company is received. The equity based incentive compensation plan comprises one or more employees (1) receiving an award grant of one or more shares of the security, or interests therein; and (2) purchasing one or more shares of the security with funds borrowed from a third party lender. A loan repayment amount, a loan duration, and a loan amount that the third party lender offers for one or more loans made to an employee, or for the benefit of an employee, to purchase the one or more shares of the security are also received. The loan collateral includes, in whole or in part, one or more awarded and purchased shares of the security in the equity based incentive compensation plan.

Next, the equity based incentive compensation plan is established by the receipt of the one or more awarded shares and the purchase of the one or more shares using the loan amount to be held directly by or in behalf of the one or more employees. Finally, the ratio of at least a portion of the loan repayment amount divided by the value of the collateralized shares is calculated, and one or more of the third party lender, the employer, or the employee is notified of the ratio.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, DVD, or other optical disk storage, magnetic disk storage or other magnetic storage devices, or any other medium which can be used to store desired program code means (software) in the form of computer-executable instructions or data structures and which can be accessed by a general purpose or special purpose computer.

A “network” is defined as one or more data links that enable the transport of electronic data between computers and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer RAM and/or to less volatile computer storage media (devices) at a computer. Thus, it should be understood that computer storage media (devices) can be included in computer components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computers, which are linked (either by hardwired data links, wireless data links, or by a combination of hardwired and wireless data links) through a network, both perform tasks. In a distributed system environment, program modules may be located in both local and remote memory storage devices.

Overview of Equity Based Incentive Compensation (EBIC)

EBIC includes automated support for illustrating and administering a new employer sponsored benefit plan funded with an employer equity security or securities (“stock” or “shares”). The term stock shall mean any private or publicly traded security representing an ownership interest in an employer's business. While the invention is ideally suited for the publicly traded common stock of a corporation, other forms of business ownership equity are equally applicable—partnerships, trusts, Limited Liability Corporations, Limited Liability Partnerships, etc.

Furthermore, EBIC includes a computerized system and method for illustrating and administering a benefit plan where the source of funding is a combination of contributions by or on behalf of the employee and loans incurred by the plan. In order to access debt that is non-recourse and/or has favorable terms, the invention includes a comprehensive loan monitoring system. Prior to implementing such a program, a potential plan sponsor will need to analyze its cash flow and earnings consequences of a proposed EBIC plan. Also, a company will want an estimate of the benefits to its eligible employee participant or participants. Accordingly, the computerized illustration system creates financial forecasts to model the performance of an EBIC plan for one or more plan sponsors and participants. After an EBIC plan is established, the efficient administration and compliance with plan terms is assured through the performance and tracking system module interfacing with the loan monitoring system.

EBIC gives employers an attractive equity based compensation tool to use instead of the existing various forms of stock options. The EBIC overcomes many of the inherent deficiencies of stock options that exist under GAAP accounting rules. For the participant, there is greater opportunity to accumulate more stock in the employer than with the stock option or restricted stock award plans.

To implement EBIC, an employer creates a written employee benefit plan (the plan) setting forth its benefits and terms. The plan may be embodied by the use of an employee grantor trust, a segregated brokerage account with irrevocable instructions or similar plan structure. The plan acquires employer stock via two sources. The first source is an award of employer stock (which is normally subject to a participant performance or a market condition which cause the shares to be “restricted” under GAAP, and the second source is one or more loans from a third party lender. The plan uses some or all of the award shares and loans to purchase and hold employer shares until a predetermined date.

The EBIC plan is not a tax qualified pension plan or otherwise qualified for a tax advantage. From this point forward, for simplicity it is assumed that the EBIC plan form is an employee grantor trust. It is to be understood that other structures can also be employed including a segregated brokerage account. The plan neither qualifies for nor claims any special tax advantage for itself, the participants, or the corporate plan sponsor. Indeed, one advantage is that EBIC does not rely on any new or not known interpretation of the tax law.

The plan's taxable income is reported in the year realized on the plan's trust income tax return. The trust return form K-1 (or a Form 1099) itemizes for each participant/beneficiary his share of taxable income, loss, expense, credit or other item to be reported by the participant. All plan contributions or awards are after tax amounts that create the employee's tax basis in the stock acquired thereby. The basis of the purchased stock equals the acquisition price.

Finally, the EBIC program may obligate the employer (i.e. the plan sponsor) to make contributions to the plan sufficient to reimburse the plan's cost while the plan beneficiary is an active employee. EBIC costs are identified in the written plan and may include interest on the plan loans. Some plans will also identify the purchase of put contracts or similar hedge vehicles as an expense to be reimbursed.

An EBIC plan may require the plan sponsor to make periodic interest-reimbursement contributions contingent upon continued employment of a plan participant. Any such contribution is income to the participant and a compensation expense for the employer for GAAP and tax accounting. Therefore, when such an employee terminates prior to the plan termination date, his plan may forfeit the opportunity to receive any future awards or contributions (cost reimbursements or otherwise) from the plan sponsor. Also, the terminated employee may be obligated to reimburse the plan for any post-employment plan expenses. Alternatively, termination of employment may cause the plan to pre-maturely liquidate, retire the plan debt and distribute any remaining plan assets to the participant.

Another EBIC plan may not reimburse an employee for loan interest. In this instance, all costs related to the borrowing may be deferred until the date the loan is due in a lump sum, known as a balloon payment amount. In such a plan, the plan may be required to repay the balloon amount prior to terminating. Accordingly, some the plan stock may need to be sold by the plan before it can make its final distribution to the participant.

The following is a simple numeric example of the operation of the EBIC program. The employer designates that 6 shares with a value of $100 each may be awarded to the employee in an EBIC plan. If the employee elects to have the value of the share award treated as taxable income at the award date, the company pays $400 of tax to the Internal Revenue Service. At a combined federal and state tax rate of 40% (for both the sponsor and the participant), the participant has compensation income of $1,000 but no out-of-pocket tax to pay. The employer's tax compensation expense is also $1,000 and as a result generates a tax benefit of $400. Inasmuch as the share compensation requires shares, but not cash, the tax benefit of the compensation expense equals the tax reimbursement paid to the employee. Accordingly, the plan sponsor's cash flow at the grant date should be zero or close to breakeven. As a result, in an EBIC plan both the plan sponsor's and the participant's cash flow should be at or close to breakeven.

Assuming a deemed 40% tax rate in the written plan, the EBIC plan may borrow $0.67 for each $1.00 of share award. Accordingly the plan borrows $400 and purchases 4 additional shares at the market value of $100 per share. At the beginning of the plan, the employee/participant is in the enviable position of controlling 67% more shares than if his award was limited to the initial 6 share award.

It is important to recognize that for the employer, the loan and the purchased shares are of little consequence, other than disclosing the terms of the plan in its proxy statement and Security and Exchange Commission (“SEC”) annual report disclosure requirements for executive compensation. The loan is the obligation of the EBIC plan only and accordingly, there is not a GAAP requirement to accrue the plan's loan and interest on the sponsor's balance sheet. Because the purchased shares are bought by the plan and not awarded, these shares are not new shares to include in the number of shares outstanding in a fully diluted earnings per share GAAP computation. Finally, purchased shares do not create any additional compensation GAAP expense for the plan sponsor.

At some point during the term of a plan, the plan pays interest on the loan. In the above example, the annual interest may be $20 assuming a debt of $400. Also, under the terms of the plan, the employer may be obligated to contribute funds to the EBIC program sufficient to meet the expense obligations for all plan participants who are active employees. When the plan receives a $20 contribution, the employee reports $20 of compensation as taxable income on his W-2 and the employer deducts the $20 as compensation expense for book and tax. In addition to the $20 of compensation to report, the employee also incurs $20 of investment interest expense via the plan. This investment interest expense is reported to him on the plan K-1 or a Form 1099. Under current tax rules, the investment interest expense is tax deductible to the extent of investment income reported from all investment sources of the employee. Unused investment interest expense deductions carry forward indefinitely and are available to offset the employee's future investment income. Accordingly, the $20 is both income and interest expense to the employee participant. For many participants, the two items may offset in the calendar year they are reported.

The employer's cost of the EBIC program is simple to compute. For example, when the plan contributions to purchase stock are made solely by the participant, the employer's cost is its contributions to cover the purchase of put contracts, administrative expenditures, and interest expense. In the above simple example, that expense is $20. Because this expenditure is a compensation expense which is dependent upon the continued employment of the participant (excepting any minor timing differences) the book expense, the tax expense and the plan sponsor cash flow expenditure all fall within the same time period. These same accounting rules apply where the plan calls for a contribution to match an employee's contribution or the plan calls for unmatched employer contributions.

GAAP rules call for the computation of a present value of the option as a compensation expense using a Black-Scholes or similar model. To better understand the rule, assume a stock with a current value of $100 per share and an estimated future value of $225 when the ultimate exercise of the stock option occurs. Ten options are granted. The projected gain is $1,250 at an option exercise date—i.e. $125 per share. That present value of the gain to the employee is $500 at the date of grant per the Black-Scholes model. The $500 is the gross book expense of the employer at the date of the option grant. The gross book expense is amortized straight line over the period estimated between grant date and the option exercise date. If the option is expected to be exercised in five years, the annual book expense is $100.

The taxation of stock options to employees has been well defined for more than 30 years. Upon exercise of the option, in the example the option price of $1,000 is paid by the participant to the employer. Also, the executive reports the market value in excess of the option price, $1,250, as ordinary income at the exercise date. Thus, assuming a 40% tax rate, the exercise of the option triggers $500 of tax due from the participant whether or not the optioned shares are sold or are held thereafter for appreciation by the owner of the stock option. Adding the option price and the tax incurred, the participant is out of pocket $1,500 to acquire stock with a value of $2,250. Since the typical stock option is measured in 100s or 1,000s of shares, most often the option holders completely liquidate the shares to cover their acquisition cost or sell just enough shares at exercise to cover the cash needs of the exercise and only take the remaining shares in kind (known as “cashless” option exercise).

The employer's tax stock option expense is different than its GAAP cost. The tax rules require a match of employer/employee compensation timing and amount. Accordingly, at exercise of the stock option, the employer records the $1,250 as a compensation expense. Because neither the sale nor the purchase of a company's own shares is taxable, the $1,000 option proceeds are simply a credit to cash and a debit to shareholder equity.

Assuming the same number of plan shares and share prices as above, a participant's EBIC plan acquires 10 shares of employer stock with a combined tax basis of $1,000 and subject to $400 lien. If the employer shares are sold at $225 each, the gain is $125 each share. Because the tax basis and holding period began at plan inception date, gains should be taxed as long term capital gain. Assuming an effective rate of 20%, the tax is $250. The example plan pays the loan principal and accrued interest at plan end in the amount of $600. Numeric comparison of the two choices is set forth below.

| Plan Type | Stock Option | EBIC program |
|---|---|---|
| Sales Proceeds | $2,250 | $2,250 |
| Cash Invested | $1,000 | $600 |
| Tax | $500 | $250 |
| Loan | N/A | $400 |
| After-Tax Profit | $750 | $1,000 |

EBIC also compares favorably to a Restricted Stock Award (“RSA”). There is no purchase price for the award grant. To compare EBIC and RSA plans, debt shares must be backed out. Accordingly, an RSA of 6 shares is assumed. When the share restrictions lift (known as “vesting”) the participant has income equal to the value of shares. In the example, the share value is $1,350 assuming $225 per share. After a tax payment of $540, the participant is left with $810 in shares and/or cash.

In the above examples, the participant gains $250 over the stock option alternative and almost $600 or more of additional wealth with the same number of shares in a traditional RSA. Still, there are disadvantages to the alternatives. In the example, EBIC requires upfront cash for the executive to initiate his participation by a purchase instead of an award and may require a tax reimbursement as discussed above with an award plan. With a stock option, the executive does not have to make an investment until the exercise date. On the other hand the stock option gains are taxed as ordinary income at the exercise date. Similarly, with RSAs the tax event occurs at the end of the transaction with vesting of the shares. Assuming an EBIC plan with an election to be taxed at the award transfer to the plan or an award purchase at plan inception, there is not a tax event when shares are distributed by the plan. Also, the participant receives the plan's tax basis and holding period on the shares received from the plan. As a result, there is no need for the participant to sell shares to meet transaction costs. Note that the plan liquidates its debt (by selling shares) before distributions to a participant. There are no liens on EBIC plan share distributions.

With the stock option, there is a significant participant transaction tax cost triggered by the option exercise. The total plan sponsor RSA and EBIC GAAP share cost should be similar. Both RSA and EBIC are assumed to award the same number or restricted shares (in the example, six shares) with the same vesting date. Furthermore, it is assumed that the participant is not reimbursed interest on the plan loan (as in the above example). That said, GAAP requires that the plan sponsor take the fair market value of the award shares at grant date as the gross book expense, and amortize that amount straight line over the period between the grant date and vesting date. In the example, six shares times $100 of value equals $600 gross book expense for the share award.

Under the Black-Scholes model computation for stock options, the gross book expense can be from 20% to 80% of the current market value of the stock. In our example, we assumed 50% or $500. The annual expense depends on the respective amortization periods of the various award plans. Also, generally stock option grants may include more share awards than an RSA or EBIC plan. Either way, the book expense difference will vary by the amortization period and the gross book share expense. Differences can be very large. Below is a comparison of the gross book share expenses for the alternatives:

| Incentive Plan | Gross Book Share Expense |
|---|---|
| Black-Scholes Stock Option | $500 |
| Equity Based Incentive Compensation | $100 |
| Employee Purchase/Employer Interest | |
| Payment for 5 Years | |
| Equity Based Incentive Compensation | $600 |
| without Purchase or Interest Reimbursement | |
| & The Restricted Stock Award | |

Returning to the employee's perspective, it is important to recognize in the above example that with a purchase of award shares and no tax reimbursement, he is out-of-pocket $600 at the beginning of the stock acquisition cycle. With the traditional stock option plan, the participant pays for the stock (and pays ordinary income tax on the stock appreciation) when the option is exercised. Of course, if an employer underwrites the full cost of participation in EBIC (including a tax reimbursement) and does not require any employee contributions, then the employee's out-of-pocket cost becomes zero. EBIC programs without awards of restricted shares can be designed to allow executives to contribute up to certain fixed amounts to the plan, and the employer can provide a matching contribution governed by the plan's formula. For example, the employer might contribute $0.50 or $1.00 of after tax funds for each $1.00 of participant contribution.

To demonstrate the consequences of a matching provision, assume a plan provides a dollar for dollar matching of allowable contributions from the participant. Our example executive contributes the maximum allowed under his plan—$300. With the employer match, the total contributions are $600. Adding a loan of $400 with a balloon repayment amount of $600, the plan acquires $1,000 of employer shares as in the first iteration of the example. In this instance, the participant realizes more than 70% additional gain than the stock option alternative:

| Plan Type | Stock Option | EBIC Program |
|---|---|---|
| Sales Proceeds | $2,250 | $2,250 |
| Cash Invested | $1,000 | $300 |
| Tax | $500 | $250 |
| Loan | N/A | $400 |
| After-Tax Profit | $750 | $1,300 |

Of course, the employer cost would increase by the amount of the matching cost paid. A $300 after tax match costs the employer $500 pre tax (at a 40% tax rate). An RSA plan, by definition can only have restricted shares and as such, is not comparable.

| Incentive Plan | Gross Book Share Expense |
|---|---|
| Black-Scholes Stock Option | $500 |
| Equity Based Incentive Compensation | $300 |
| Plan | |

The Invention system also enables the employer to offer a put option on employer stock. If the employer stock declines in value, the plan exercises its put, realizes cash (with no taxable gain or loss), and repurchases employer stock at a lower cost per share. (An alternative but less tax efficient approach would be to close the put contract at a gain and use the proceeds to purchase additional shares of stock. The plan would have the same number of shares via both routes, but more taxable gains to report with a sale of the put contract.) Afterwards, the plan owns more shares with no change in the original investment. With such a structure, the plan avoids loss of capital via the put. The plan can make the funding cost of a put the responsibility of the employer or the employee, or some combination thereof. Where the employer makes a contribution to the plan sufficient to fund the put cost, such as $5, the total annual cash cost of the ERIC program becomes $5. Also, the annual cost of the put would decline where the put price is fixed at the original cost basis of the stock ($100 in our example) and value of the stock grows over time. Accounting for the cost of the annual plan expense reimbursements ($5 in year one) is the same for GAAP and tax (i.e. employer contributions are reported as employee compensation).

One elective feature permits the employer to pay plan participants a tax gross up on some or all contributions to the EBIC program to cover the put purchases, interest expense, administration and/or other plan expenditures. Another optional feature is a series of annual rolling puts that start with each year's beginning share price and thereby locking in the prior year's appreciation. Such a provision adds cost to the plan, but also adds a very attractive executive incentive compensation benefit. Whatever stock appreciation occurs over the initial plan purchase stock basis for each year is a gain the plan participant gets to keep. The EBIC system provides cost estimates of these additional features to thereby help an employer to select the features it wants to offer.

At a specified age, death, date, or at retirement, an EBIC plan calls for a distribution of its assets to the participant. (Alternatively, the plan could require the sale of its assets and a distribution of cash to the participant). Before a distribution occurs, to comply with ERISA, the plan repays its outstanding loans. ERISA prohibits asset distributions subject to debt. The loan repayment comes from a sale of selected (or all) plan assets i.e., the employer stock. Once the plan debt is retired, plan assets (cash and/or the remaining stock) are distributed to the participant.

For income tax reporting purposes, all activities of the EBIC program flow through to the plan participant(s). In most instances, a grantor trust is the entity to hold the plan assets and each year the trust provides a participant with a Form K-1 reporting the amounts of gains and losses (ordinary and/or capital) by attribute (interest expense, dividend income, etc) to be included in the participant's income tax return. Where a particular EBIC program calls for a full liquidation of all investments at the plan distribution date, all gains and losses from the plan assets and all plan expenses are reported for income tax purposes to the plan participant at that point in time. If the plan only liquidates sufficient assets to retire the loan at the distribution date, then the only gain or loss recognized at that time is from the stock (and other assets, if any) sold by the plan. The remaining stock is distributed to the plan participant in-kind. Since the plan vehicle holding the assets is a grantor trust, the “in-kind” change in ownership is not a taxable event. The holding period and tax basis carry over from the grantor trust to the participant-recipient.

It is possible for an employer to create an EBIC program that extends past the retirement of the participant. Doing so, however, generally requires the plan sponsor to shoulder the annual administrative responsibility and cost with respect to the plan into a future when employee incentives are not relevant. However, a final distribution at a predetermined date or the participant's retirement date is the simple and most cost effective approach. Once the distribution occurs, the employer is no longer involved with the beneficiary (e.g., the retiree) and the plan terminates with respect to that participant.

For some, a final distribution occurs prior to the written plan date. When an individual leaves a company, the EBIC program may offer the terminated individual three options. First, he can elect to receive a final liquidating distribution (net of loan and interest repayment). Secondly, the individual can elect to have the plan sell sufficient assets to retire the plan's debt and accrued interest. With this second election in place, the participant receives his distribution of the remaining assets at the date originally specified in the plan when he was an employee. Either way, the terminating plan participant avoids having to make contributions to cover future loan interest obligations by retiring his portion of the plan's debt at termination. Finally, a plan may permit or require a terminating employee to leave the plan loan in place until the scheduled termination date.

On Jul. 30, 2002 the Sarbanes-Oxley Act (“Act” or “Sarbanes-Oxley”) became law. Sarbanes-Oxley is a strong Congressional reaction to accounting failures and officer malfeasance uncovered at some major public corporations during the first few years of this century. The Act grants the Securities & Exchange Commission (SEC) new regulatory powers, requires new corporate financial reporting by SEC registrants, and creates a new governmental accounting body with oversight of SEC registrants. Sarbanes-Oxley also prohibits SEC registrants from making loans to their directors and senior officers. More precisely, Section 402 of the Act prohibits personal loans to a director or a senior executive officer of an SEC registrant. This prohibition applies where the loan was arranged by the registrant or the loan was indirectly or directly extended by the registrant. While expert SEC lawyers unanimously agree that an EBIC program, with participants who are directors and senior officers, does not violate Act Section 402, the SEC has steadfastly refused to respond to any requests for guidance on any factual determination of the application of Section 402 or other sections of the Act.

In response to this minor uncertainty, EBIC includes an optional application which circumvents exposure to a possible interpretation that the EBIC program violates Section 402 of the Act. Under this option, employer matching of employee contributions to a plan may occur in the same form and fashion as above to purchase stock and/or put contracts. What is different in this optional application is that the participant must make an election to have his plan borrow additional funds to buy additional stocks. Also, the participant is responsible to make timely contributions to provide the plan with funds to meet its interest expense obligations. Failing these contributions, the plan has the authority to sell plan assets or incur additional debt to meet plan interest obligations. Also, a plan may be structured for senior executive loan interest to be due at the end of the plan.

One aspect of the EBIC program is the loan and the loan monitoring process. The loan is non-recourse as to the plan-sponsor, the plan-fiduciary, and the plan-participant. The collateral for the loan is the stock held by the plan. Periodically (typically overnight) the computer system obtains and compares the plan assets' market value with the plan loans outstanding and reports to the lender and/or the plan administrator when certain pre-determined plan defined ratios are exceeded.

The Federal Reserve Bank Board of Governors has the statutory authority to administer margin loans (debt secured by securities). For purposes of these Federal Reserve Bank rules, “securities” are equity or stock instruments. Bonds or similar interest bearing instruments are not securities for purposes of margin rules. There are two sets of margin rules—Regulation T (Reg. T) is for broker-dealers lending to their brokerage customers. Regulation U (Reg. U) applies to all other lenders.

EBIC programs use Reg. U lenders. Under Reg. U, lenders are prohibited from making additional loans where the fair market value of the collateral is less than 50% of the loan amount. The test applies each time a loan is advanced. When computing the ratio test, the lender is required to include then existing loans and their stock collateral in the computation. For each proposed loan the EBIC system monitors the loan to value ratio for each plan participant and notifies the lender of the maximum loan allowed in connection with a new award of restricted stock and when a proposed loan violates the Reg. U requirement. Receiving this analysis on a timely basis, the lender is assured that any loan advances are incompliance with the Federal Reserve Bank regulations.

The rules under Reg. T are the most familiar margin rules. Stockbrokers are required to maintain no more than a 50% ratio of loans secured by securities purchased by their customers. Accordingly, there are margin calls for additional funds to be deposited with the broker and sales of collateralized shares when margin calls are not met. Falling under Reg. U has the decided advantage of not having to have margin calls. Once the 50% ratio is exceeded, the lender simply cannot make any further loans, but does not have to reduce existing loans by liquidating account assets. Again, it is important that the lender to a plan qualify as a Reg. U lender.

To provide timely information, the plan loan to value ratio computations may be completed and reported frequently (e.g., daily). The EBIC system electronically computes the periodic loan to value ratios for multiple plans and each of the individuals within an EBIC plan. This information is distributed electronically via modem or the internet to the end users. As noted above, prompt and accurate reporting to the lender is particularly important.

An EBIC plan can specify which shares held by the plan are collateral for the loan or loans obtained to acquire shares of the plan. For example, the collateral may include all the shares purchased with loan funds, all the shares granted to the employee, or any combination of these shares. Virtually any combination of shares can be specified as the collateral as long as the total amount due on all loans does not exceed 50% of the fair market value of the collateralized shares.

For example, if a plan acquires 10 shares valued at $100 each, 6 by grant and 4 by purchase using loan funds, the loan amount is $400. Therefore, the collateral for the loan must be at least 8 shares. This would give the required 50% ratio ($400/$800). The 8 shares may consist of all 4 purchase shares and 4 award shares, all 6 award shares and 2 purchase shares, or any other combination.

At any subsequent time when the plan desires to receive additional loans to purchase more shares, this 50% maximum ratio must be maintained. Consider the example where the 10 shares have increased in value to $200 each at the time an additional loan is desired. The fair market value of the collateralized shares is now $1600 (8*$200) while the loan amount is $400 plus any accrued interest giving a ratio of 25%. In this simple example, a loan could be made (e.g. up to $400 less accrued interest on the original $400 loan) without any additional shares being included as collateral. Of course, additional shares (whether from grant or from purchase using loan funds) could be included as collateral for the additional loan.

To summarize, every time a loan is made to a plan to purchase shares, the total outstanding loan balance (i.e. principal and interest) of every loan made to the plan must be calculated to determine the ratio of the collateral to the total loan balance of all loans. This calculation not only determines whether additional loans can be made, but also the amount that can be loaned. The EBIC computer system facilitates these calculations providing the user with both periodic and on demand calculations of these figures.

### An Alternative Embodiment of EBIC

In the implementation of the original embodiment of EBIC as described above, the trigger ratio reporting feature (i.e. a report that a defined ratio at which the lender requires the sale of shares to protect its investment has been exceeded) has not proved to be attractive to lenders. The concern with the trigger ratio is that it does not protect the lender in a “melt-down” incident. A share price melt-down takes place when negative news about a company comes out during non-trading hours, such as overnight, holidays, and weekends. In such a case, a share trading at $25 on a Friday might open at $1 on Monday morning. With such a dramatic and immediate loss of value, the trigger ratio report will not afford the lender an opportunity to recover its loan via a sale of the collateral during the course of the melt-down event.

At first blush, the plan might offset the melt-down risk by purchasing a put contract on the shares. A put contract allows the owner of the contract to sell (in other words, “put”) a number of shares at a fixed price during a given period of time. So, if the plan owns put contracts on its shares, in a melt-down it can exercise the put and use the proceeds to repay the lender.

Put contracts have two problems. First, they become expensive when periods past one year are designated to create a multi-year contract, or when buying successive years of six month or one year contracts. Accordingly, puts may eliminate much of the economic benefit of the EBIC plan. Secondly, when a taxpayer owns shares of stock with matching put contracts, the tax holding period is suspended because the owner of the shares is no longer at a risk of loss. Accordingly, if the plan has a put throughout its holding of the plan shares, at termination of the plan, the holding period will be a matter of days. Accordingly, a sale of the shares to repay debt will incur ordinary income tax on short term capital gains.

To qualify for long term capital gains treatment, for some period during the plan duration, there must be a one year period during which there is no put on the plan's shares. The obvious quandary is that for the participants to enjoy long term capital gains treatment, the lender has to be prepared to accept melt-down risk during some time period. To satisfy both the lender and the plan, the original embodiment of EBIC has required undo complexity and case by case engineering. In other words, the original embodiment of EBIC oftentimes has limited appeal given the difficulty of simultaneously fulfilling the objectives of plan lenders and participants.

To address these deficiencies of the original embodiment of EBIC, an alternative embodiment of Equity Based Incentive Compensation has been developed. In this alternative embodiment, the plan is structured with risk abatement strategies to minimize the risk to the lender. By employing these strategies, the need for day to day loan monitoring is also avoided.

A plan according to the alternative embodiment of EBIC performs similarly to a plan in the original embodiment of EBIC described above, except that the alternative embodiment does not require the purchase of a put contract with respect to the plan's holdings of employer shares, the receipt of employer contributions to pay for interest, or a Trigger Ratio for the lender. To make nonrecourse debt available from a lender without these provisions, the alternative embodiment adds a replacement feature and a structure modification. First, the plan sets a fixed date repayment schedule. This loan repayment schedule can only change under extraordinary circumstances which may incur a transaction penalty from the lender. Typically the plan loan repayment amount is the sum of principal and interest between the loan date (grant date) and the loan repayment date at or before the plan termination date, normally shortly after vesting of award shares.

Absent employer contributions, plans will generally not have the liquidity with which to remit periodic interest payments to the lender unless shares were to be sold by the trust. Of course, such a sale would reduce the plan's share holdings and thus would work against the purpose of the plan. Accordingly, plans pursuant to the alternative embodiment of EBIC may be structured such that the debt and interest payments will be due immediately following the vesting of the corresponding plan shares and before the termination of the plan or a plan segment.

Note that a given award grant may consist of multiple tranches. Each tranche's shares may vest, and a pro-rata loan may become due on a separate maturity date. For example, 20% of an award may be scheduled to vest in each year for five years after the grant date: 1^{st}, 2^{nd}, 3^{rd}, 4^{th} and 5^{th} anniversary dates. If this vesting schedule applies, then 20% of the loan (plus interest on the 20% of the loan) will be due on each of the five anniversary dates.

The loan agreement may provide that the plan can repay the loan with cash or with all the shares held as collateral. When the value of the collateral shares of the plan exceeds the plan's loan balance (including interest), the plan may sell sufficient shares to repay the loan repayment amount. The remaining plan shares may be distributed to the participant and the plan terminated. If the loan balance is less than or equal to the value of the collateral shares, the plan may deliver the collateral shares to the lender in full satisfaction of the debt obligation. The lender immediately disposes the shares and retires the debt.

However, to avoid the scenario where the lender may incur a loss on the shares received in payment of the loan (i.e. when the value of the collateral shares is less than the loan balance), the lender may enter into one or more sophisticated hedging transactions known as forward contract swaps—a prepaid forward contract or a similar derivative set of futures contracts (“forward contract”) with a counterparty. This hedge may be put in place at the plan's award grant date. Reduced to its most basic element, at plan termination the lender may receive a contract determined number shares from the plan in lieu of cash to repay the loan and accrued interest. Repaying the loan in shares will normally occur when the shares value is less than the entire loan repayment amount. The forward contract enables the lender to deliver the shares received to the counterparty of the derivative contract. In return, the lender receives a payment from the forward contract counterparty. The forward contract may define a payment of any amount, but generally the payment is sufficient to equal the loan principal and accrued interest. To limit risk and reduce the cost of the transaction, collars, puts, calls, or other derivatives of various durations and descriptions may be embedded in the hedge.

The forward contract may hedge the shares of the company held by the plan, the shares of industry index funds, or a combination of shares in the company and the industry index funds. Where a plan sponsor's shares have small trading volume, index fund shares may prove useful in assuring liquidity in the hedge.

Accordingly, with a fixed plan termination date the lender is able to utilize a forward contract to minimize any loss of principal or interest on the loan. The cost of the hedge may be recovered in the rate of interest charged for the loan. Because of the efficiency of the forward contract structure, the interest rate with the cost recovery element is still attractive to the plan and its participants. Of course, the cost of the hedge varies greatly depending upon the volatility of the shares hedged, the financial health of the company whose shares are hedged, etc.

Accordingly, this alternative embodiment eliminates the need for put contracts inside the plan and for a trigger ratio computation and reporting by transferring all the risk abatement responsibility to the lender. In turn, the lender recaptures its cost through the rate of interest charged for both the use of capital and the risk assumption inherit in a nonrecourse loan.

The risk abatement strategies added to EBIC in this alternative embodiment better enable the parties' objectives to be met. Because puts are not required in this alternative embodiment, the plan participant is generally able to report long term capital gains on plan shares sold at plan termination, and have a long term holding period attached to shares distributed by the plan. With a fixed plan termination date, the lender can use the forward contract to efficiently hedge some or all of its risk in the nonrecourse loan. The cost to the lender of the forward contract may also be offset by increasing the interest rate accordingly. Further, plans according to the alternative embodiment are generally simpler and easier to explain than plans according to the original embodiment.

Similar to the original embodiment, in the alternative embodiment of EBIC, the employee (or plan participant) receives an award of employer shares, and the plan borrows (on behalf of the participant) using the award shares as collateral. The credit advance may be used to purchase additional employer shares. If there is a service or performance restriction on the awarded shares, the employee makes a tax election (see Internal Revenue Code (“IRC”) Section 83(b)) to treat the shares as taxable income without regard to the restrictions to be fulfilled. As a result, the tax basis and holding period for the employee are fixed at the onset of the plan. The election also generates a simultaneous compensation tax deduction for the employer. At this point, the employer may make a tax reimbursement on behalf of the employee to avoid or to minimize any employee tax obligation that might arise from the IRC Section 83(b) election.

In the alternative embodiment, the date the shares become available to the plan participant for his or her unrestricted ownership is predetermined by the written plan. The life of a plan may be any time period, but two to five years may be the norm. Accordingly, the federal income taxation of a disposition or transfer of shares at plan end may be at long term capital gain rates. In contrast, NQSO exercise date and RSA vesting date gains are taxed at ordinary income tax rates. Where the employer provides a tax reimbursement to the employee as a part of an EBIC plan, the employee's after tax cost of sponsoring the plan becomes approximately zero.

The employer also enjoys advantages as a plan sponsor of a plan according to the alternative embodiment of EBIC. Using treasury shares to fulfill the restricted share awards in the plan, the plan sponsor may avoid negative after-tax cash flow from the compensation award of shares for the plan participant. Treasury shares typically have no cash cost to the issuer, but may be deducted at the same time that the participant has taxable income to report from the award. Accordingly, the plan sponsor enjoys a tax reduction or benefit by reporting the fair market value of the treasury shares as a compensation expense. (Note: treasury shares are not required in the alternative embodiment of EBIC, but may predominate due to their cash flow benefit to the employer. The employer's alternative is to purchase the needed shares for the plan on the open market).

Once a plan according to the alternative embodiment is granted a restricted stock award, the plan can access a loan facility and use the proceeds to purchase additional shares to be held by the plan. Of course, the lending facility is created by a lender to specifically serve one or more plans. While the loan terms may vary between plans, a usual set of terms may be as follows:
Debt secured only by the plan shares—no guarantees by the plan sponsor or participant;
A loan maturity date that coincides with the termination of the plan or plan segment;
Loan principal and interest payments may be deferred until the loan maturity date;
Where the plan award has multiple segments with different termination dates, the loan maturity may proportionately match the shares in each plan segment.
Vesting may occur on or before the plan (or plan segment) termination date.

As employer shares increase in value, leverage enhances the participant's gain. Issues may arise when the plan shares decline in value. In the original embodiment of EBIC, a loan monitoring system is in place to enable lenders to promptly convert the collateral to cash and avoid the possibility that the share collateral value becomes less than the loan balance. Unfortunately, such an early loan payoff short stops the plan shares ability to recover from a momentary decline, and of course, permanently blocks future upside potential for the plan. Once the loan is repaid, there is no opportunity for the plan shares to recover value during the balance of the plan term. Accordingly, the alternative embodiment of EBIC generally uses fixed term loans that are payable only at the plan end date without regard to oscillating share prices between plan grant date and vesting date.

Of course, a plan loan may be guaranteed by an employer with a good credit rating. A lender would generally be pleased to make such a loan to the plan. However, this route has a number of significant disadvantages. First, each year the present value of the guarantee cost must be estimated and accrued as a book compensation expense and as taxable income to the employee. Secondly, the employer may be required to consolidate the loan obligation on its balance sheet for GAAP reporting. Finally, the plan participant may have tax compliance issues under IRC Section 409A. Finally, such a loan guarantee might be considered illegal under Section 13 of the 1934 Securities and Exchange Act.

Overview of the EBIC Computer System

The present invention includes a computer system and methods to support, illustrate, and administer an EBIC program. The computer system implements an EBIC program with its attendant benefits to plan sponsors and their employee-participants.

It is noted that the system initially accesses, loads, and stores a variety of information on the system's computer readable memory. This information includes data that is specific to each participant and/or plan: name, social security number, address, e-mail address, telephone number(s), birth date, sex, plan name, employer, employee identifying data, stock purchase dates, allowed share purchases on stock purchase dates, loan percentage amount, election to pay off plan debt, election to not incur debt, election to incur maximum plan debt or a lesser percentage, employer maximum plan loan amount (if any), gross-up percentage on interest (if any), employer matching contribution percentage or amount (if any), distribution election with respect to gains reported for tax purposes, early participant termination elections, participant retirement termination elections, plan retirement age, hypothetical return on plan assets (if any), assumed interest on plan loans (if any), and type of security(common, preferred, convertible preferred, etc). In addition, the system receives and stores the parameters of each sponsor's EBIC program in the computer readable memory. For example, different EBIC programs have different loan ratios. In addition, the system processes and stores plan activity data on the system's computer readable memory. Individual plan data includes participant loan balance, accrued interest, number of shares by type held, dates of share acquisitions, tax basis of shares, realized gains and losses, unrealized gains and losses, contributions received, interest paid, dividends received, and other expenses. The system retrieves this information as needed to prepare reports and to update data fields as time and events unfold. The system performs even if one or more data fields are empty. The system can accept new data fields as EBIC responds to the needs of employers and employees.

Finally, the Invention includes a computer system for illustrating the performance of a hypothetical EBIC program and for computing the costs of alternative features the corporation may offer. Also, this system forecasts the future performance of an existing plan. The system forecasts the pre-tax and after-tax cash flows to participants under various assumptions. For the corporate plan sponsor, the illustration module projects the after-tax cash flow cost and the earnings charges arising from offering the EBIC program to employees. The system also can prepare comparisons of the results of an EBIC program implementation versus a stock option plan.

The loan monitoring function is useful for implementation of the plan. The Invention monitors the fair market value of the plan assets (i.e., stock and if applicable, put contracts) to ensure that there is sufficient collateral for the plan loans, when prior plans loans are in place and new loans are being issued. For shares owned by the plan and traded on one of the public exchanges, the EBIC computer system obtains and electronically records the fair market value of the plan's stock periodically (e.g. each trading day). Also, the system computes and stores the periodic loan balance and the related accrued interest. Accordingly, for each participant in an EBIC program, the system periodically computes a ratio of the participant's loan plus accrued interest divided by the fair market value of the plan assets. Once computed, the loan to value ratios are sent electronically via modem or internet to the plan lender, and stored in the computer memory. Based on the plan, this data can also be provided electronically to the participants, the plan sponsor, and/or the administrator.

Accordingly, with loans made to an EBIC program, on a given day the lender may determine the adequacy of the collateral and the availability of new loans when new shares are added to a participant's plan. From the lender perspective, it is important that this information be accurate and timely.

The EBIC computer system tracks stock values through electronic reports from a trading exchange, a brokerage company, or a third party information vendor via modem or the Internet. Most banks do not have systems in place to make daily collateral adequacy computations. The EBIC computer system independently computes and tracks loan and interest balances. There are two advantages for a lender when the EBIC system performs the loan tracking First, there is third party audit or verification of the loan and accrued interest balances. Second, the lender is not forced to track individual plan participant accounts. They can administer each EBIC program as a single loan. Individual plan participant problem loans are addressed on an exception basis when the EBIC system identifies and reports a participant loan falling below the 50% loan to value ratio specified by Reg. U.

A preferred embodiment of these types of loan provisions and the EBIC program monitoring system is as follows. After each periodic computation of the loan to value ratio, the system creates an electronic record of the loan to value ratio for each participant. Normally, these computations are performed overnight and the reports are delivered electronically via modem or the internet to the lender prior to the opening of business on the next business day. Where loan to value ratios are equal to or greater than 50%, the system creates a separate exception report. The same report includes a notice to the lender that, pursuant to Reg. U, no further advances are allowed to the noted plans, unless additional share collateral is provided.

In addition to loan monitoring, the EBIC computer system prepares and provides periodic historical accounting reports for the plan sponsor, fiduciary, administrator, and participant(s). The plan administrator uses the system generated information to prepare periodic (e.g., monthly, quarterly, annual) reports for the fiduciary and participants. The system reports include some or all of the following data for a period or periods: stock value(s), changes in stock value(s), number of shares of stock held by a plan, cost basis of shares held, gains and/or losses from stock sale(s), dividends received, plan administrative expense, accrued interest expense, interest paid, other plan income, other plan expenses, contributions received from the sponsor and/or the participant, distributions to a participant, trust capital account beginning and ending balances, put contracts in force, cost basis of put contracts, future put expiration date(s), loan receipts, loan retirements, loan balances, loan to value ratio(s),and trigger ratio(s).

If the plan is ERISA qualified, data from the system is transmitted to the ERISA plan fiduciary and to the plan administrator to prepare the annual Form 5500 for submission to the Department of Labor, the annual participant plan report required by ERISA, the annual grantor trust tax return(s) to be filed with Internal Revenue Service and the Form K-1s or Forms 1099 for each participant to report his items from the plan for inclusion in his annual tax return(s). Finally, the EBIC computer system provides data for the lender to include in its annual report to the Federal Reserve Bank for compliance with Reg. U.

There is a significant tax advantage to a participant when the plan reports and maximizes long term capital gains versus short term capital gains and ordinary income. Generally the federal income tax rate on long term capital gains is about 20% (combined state and federal income taxes) versus the top combined ordinary income tax rates of 40% or more for most executives. An advantage of lower tax rates is more money left to spend after tax.

The EBIC computer system computes and tracks all values required for income tax reporting for each plan participant. This data will be accessible to a participant electronically via a modem or the internet. Without this system, proactive tax planning would be difficult if not impossible for a participant.

If a plan incurs taxable income (e.g. a dividend), the system determines if the participant has made an election to receive a cash distribution from a plan when a taxable event occurs. This election may be made at inception of the plan and may be subject to change by the participant on a specified date of the plan. Also, when drafting the plan instrument, the company sponsor of the plan designates the amount that the plan is allowed to distribute when it realizes taxable gains. Typically, a distribution of 20% of the reported gain is allowed in years prior to the final distribution of plan assets and winding up the plan with respect to a participant. Because individual participants make different elections and an individual participant may be able to change his election over time, the EBIC computer system may compute and store all plan data on an individual participant basis.

The EBIC computer system may also provide an illustration module that facilitates the monitoring of plan loans and the preparation of user reports. The illustration system data input is a series of plan assumptions: age and sex of groups of participants, retirement ages by group, annual contribution amounts by group (by employer and/or by participant), employer matching contribution rates, restricted stock awards, income tax rates for the employer and the participant, loans as a percentage of plan contributions, loan interest rate(s), loan balloon payment, annual stock value appreciation rate(s) and/or depreciation rate(s), and annual stock dividend rate or amount. For each participant group, the illustration module may forecasts on a periodic basis: employee contributions, employer contributions, restricted stock awards, loan amounts, stock purchases, stock gains, stock losses, interest expense, administrative expense, annual income tax items to be reported by participant, participant periodic after-tax cash flow amounts, a plan termination date, a total gain or loss, a simple accounting rate of return, an internal rate of return, and a present value amount. Also, for each participant group the illustration module forecasts on a periodic basis for the employer-sponsor: the periodic after-tax cash flow cost of plan contributions, the GAAP accounting expense, total after-tax costs, and the present value of the cost.

The EBIC computer system compares the performance of the illustrated EBIC program to an illustrated RSA plan. With a single set of assumption data, the system can generate an accurate comparison of the EBIC program with an RSA plan's performance. Alternatively, the system uses a third party illustration of a RSA plan for a comparison.

Finally, the EBIC computer system compares the performance of the illustrated EBIC program to an illustrated stock option plan. With a single set of assumption data, the system can generate an accurate comparison of the EBIC program with a stock option plan. Alternatively, the system uses a third party illustration of a stock option plan for a comparison.

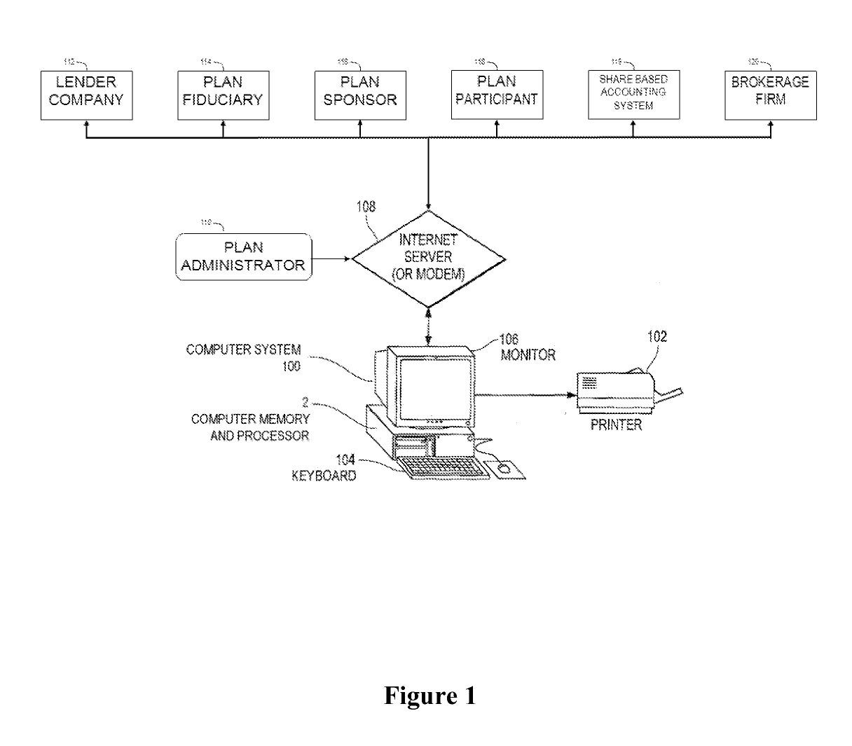

FIG. 1 illustrates an exemplary architecture of the EBIC computer system. A computer system 100 is coupled by a computer-to-computer communication device, such as, for example, an internet server 108 to a plan administrator's computer system 110. In the diagram, the plan administrator's system also serves as the conduit for data transfers to and from other parties of interest, including, a lender company's computer 112, a plan fiduciary's computer 114, a plan sponsor's computer 116, a plan participant's computer 118, a brokerage firm computer 120. The plan administrator's connection to these other computers most likely will be via an internet server or an intranet server, but may be via a modem in certain circumstances.

Separate and equally viable embodiments of the present invention would link computers 112, 114, 116, 118, and 120 directly to computer 100 in addition to or instead of using computer 110 as a conduit. In other words, the manner in which the various computers are connected is not essential to the invention.

According to these separate embodiments, the computer system 100 is operated by the plan administrator of the EBIC program. As such, the computer system 100 is external to the computer systems at 110, 112, 114, 116, 118, and 120. The computer system 100 is programmed to receive, process, and store plan event data. This data is then used to prepare historical performance computations and various measures of financial performance. The computer system 100 also uses event data to monitor the adequacy of the loan collateral under the loan agreement and assure compliance with Federal Reserve Bank leading rules. Finally, the computer system 100 permits the user to make assumptions about a hypothetical benefit plan and project its financial consequences. In addition, the computer system 100 can compute the financial results of a traditional non-qualified stock option plan and compare the results to those of an EBIC program.

The EBIC computer system 100 may include modules that execute algorithms for implementing the various aspects of an EBIC program. These include a Periodic Updating algorithm 4A, a Loan Monitoring algorithm 5A, a Performance Tracking and Reporting algorithm 6A, and an Illustrating algorithm 7A. The first three algorithms are used to reflect a specific sponsor's benefit plan design and the fourth algorithm, Illustrating algorithm 7A, permits the user to view an exemplary EBIC plan using user specified hypothetical design features.

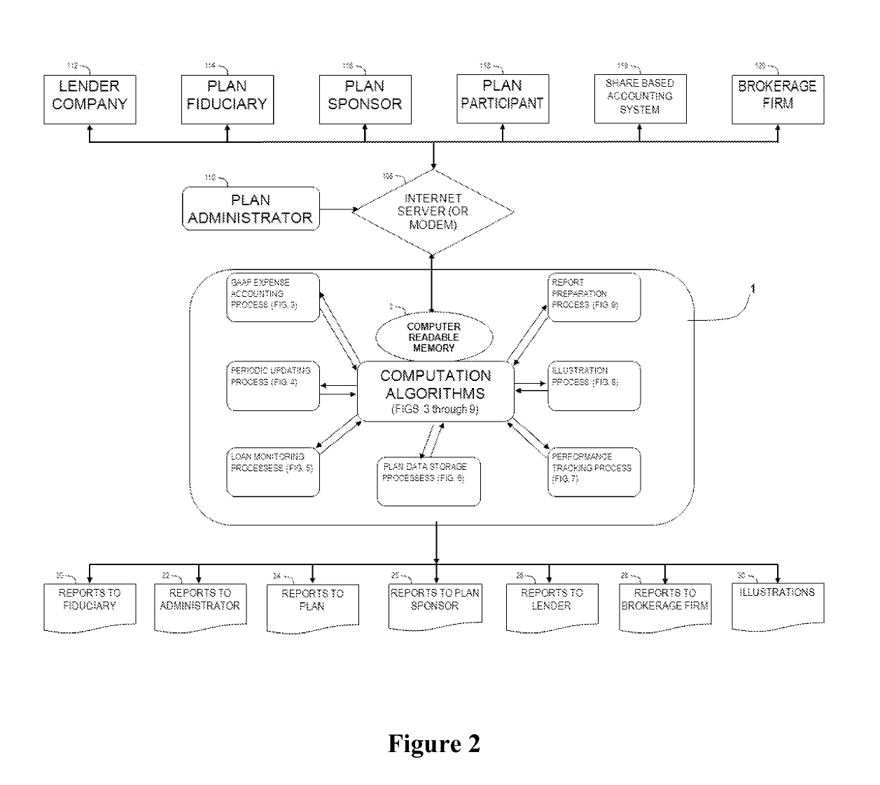

FIG. 2 is a block diagram showing the software components 1 as they structure the functionality of the present invention. Certain software components control the operation of and provide the functionality to computer system 100. The current embodiment of the present invention includes four separate process systems which can run simultaneously or separately: Periodic Update Process 4, Loan Monitoring Process 5, Performance Tracking and Reporting Process 6, and Illustrating Process 7.

In general, information transfers to and from computer system 100 and plan administrator system 110 (or alternatively between computer system 100 and systems 110, 112, 114, 116, 118, and 120). In one embodiment of the invention, the plan administrator 110 is the transferor and recipient of all information to and from computer system 100. Alternatively, all external systems could be in direct communication with computer system 100.

Accordingly, plan administrator 110 collects and transmits to computer system 100, information such as benefit plan census data, actual benefit plan events such as contribution receipts, benefit plan terms such as the availability of plan put contract purchases, user selected variables such as a net present value (NPV) discount rate and illustration assumptions such as future loan interest rates to include in a forecast of a benefit plan, or a benefit plan and a stock option plan, financial performance(s). Upon receiving information, computer system 100 stores the information in memory 2 according to the data structures of the present invention. This allows the computer system 100 to read information from memory 2 for use in the various system processes.

Each of the four system processes, Periodic Updating Process 4, Loan Monitoring Process 5, Performance Tracking & Reporting Process 6, and Illustration Process 7, generates reports reflecting its computations, data sorts, and data processing. To facilitate distribution of reports, the plan administrator 110 codes report distributions as to which system should receive which report. Accordingly, plan administrator 110 electronically receives and stores each report and electronically re-sends a received report to a lender company 112, a plan fiduciary 114, a plan sponsor 116, a plan participant 118, and/or a brokerage firm 120, depending on the report's coding.

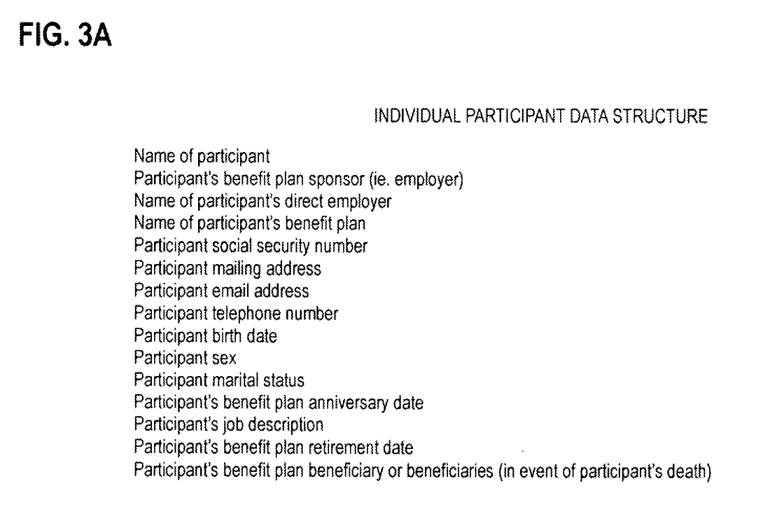

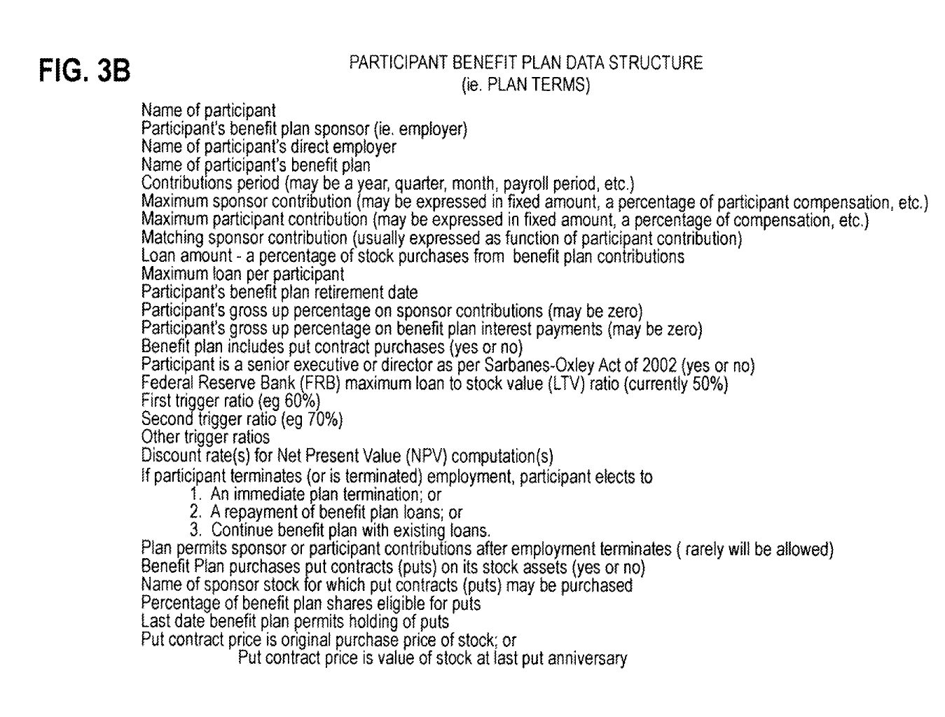

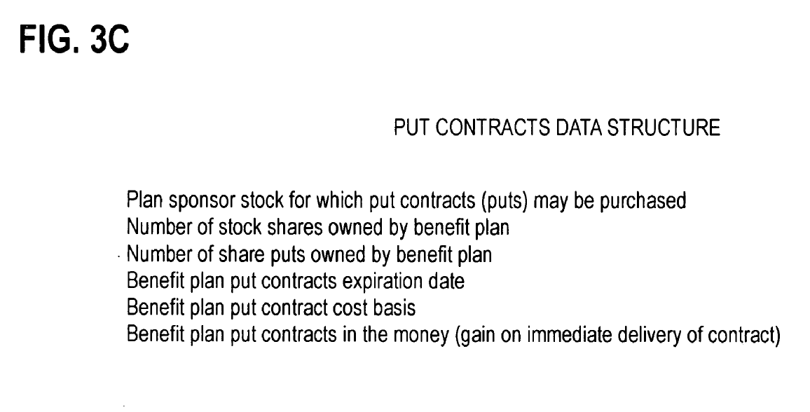

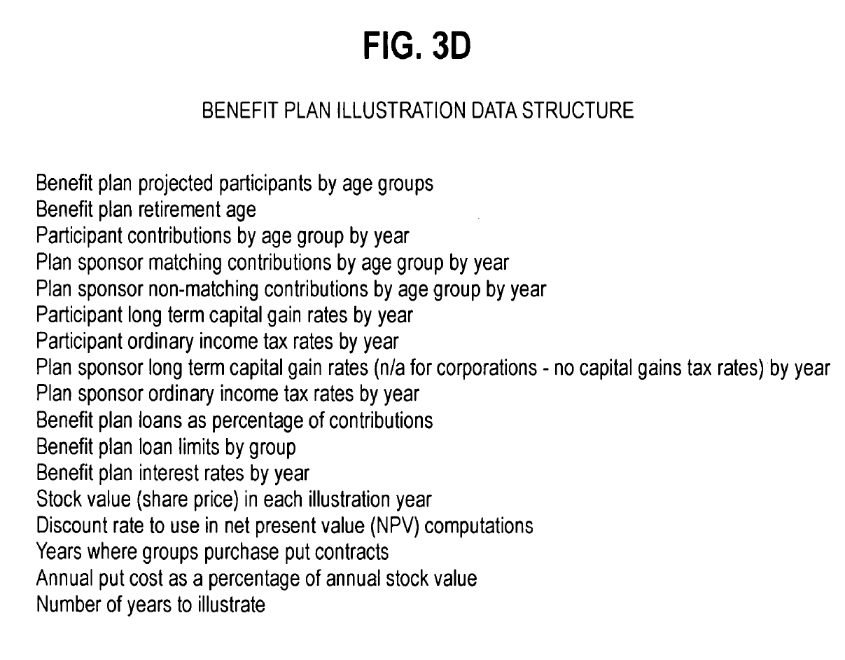

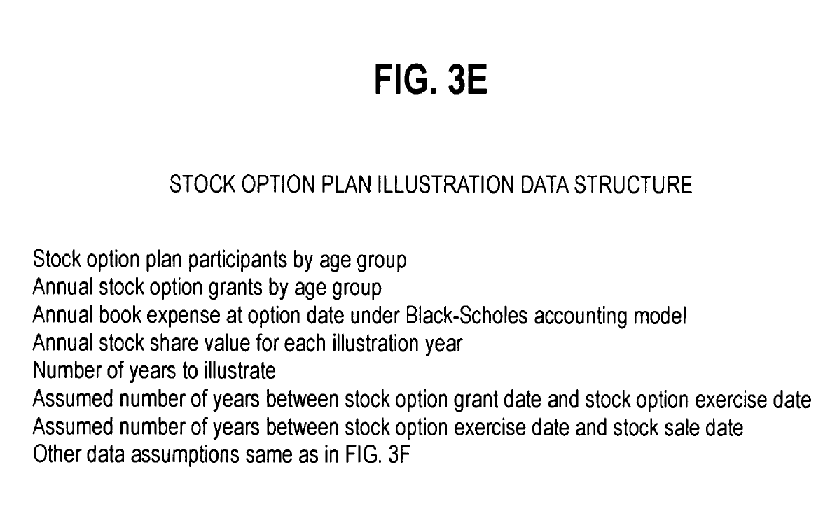

FIG. 3 sets forth in columnar form various data input items received from the plan administrator 110 by the computer system 100.

FIG. 3A reflects in columnar form the participant data structure that transfers from the plan administrator 110 to the computer system 100. This information is first gathered by the plan sponsor 116.

FIG. 3B reflects in columnar form the participant benefit plan attributes and limitations by participant. This information is received from plan administrator 110 by the computer system 100, after originating at the plan sponsor 116.

FIG. 3C reflects in columnar form the put contract data items used by computer system 100 in the loan monitoring process 5, the performance tracking and reporting process 6, and the illustration process 7. The put data originates from the brokerage firm 120 where the participant plan assets are held, and is forwarded electronically to the plan administrator 110 for further transfer to memory 2.

FIG. 3D reflects in columnar form data items to permit the computer system 100 to prepare illustrations 30 of a benefit plan.

FIG. 3E reflects in columnar form data items for the computer system 100 to compute illustrations 30 of a stock option plan.

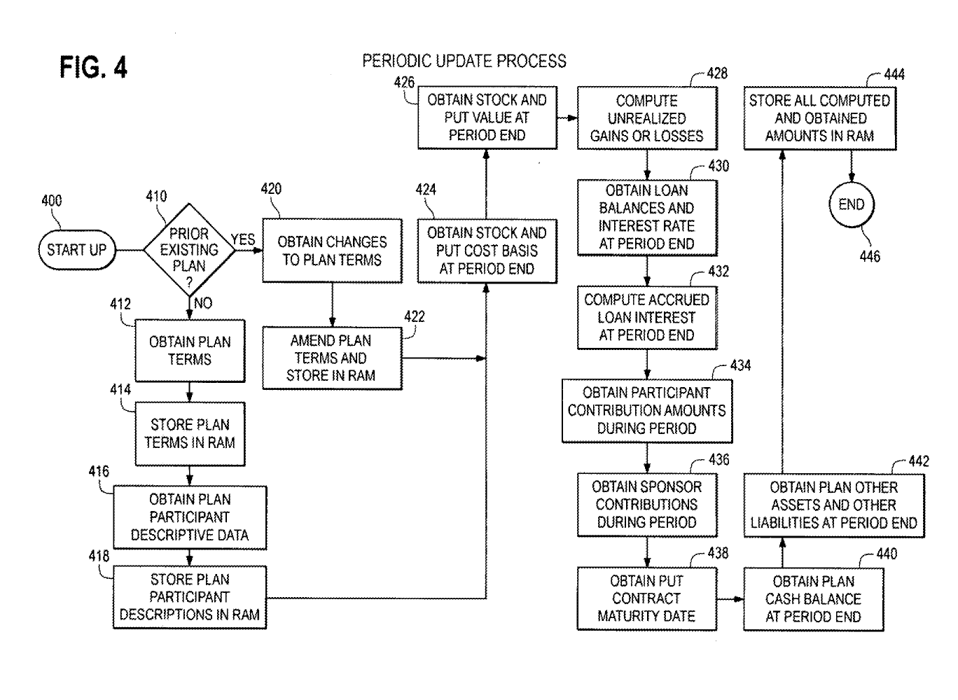

FIG. 4 is a block diagram of the periodic update process 4 of computer system 100. The steps in the system are designed to capture relevant benefit plan data and event data for each participant and timely record the information in memory 2.

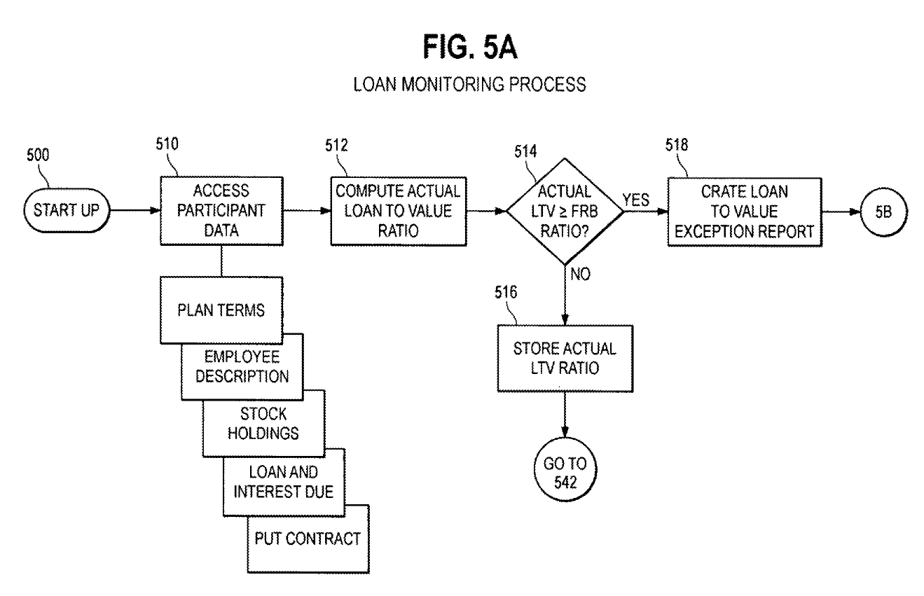

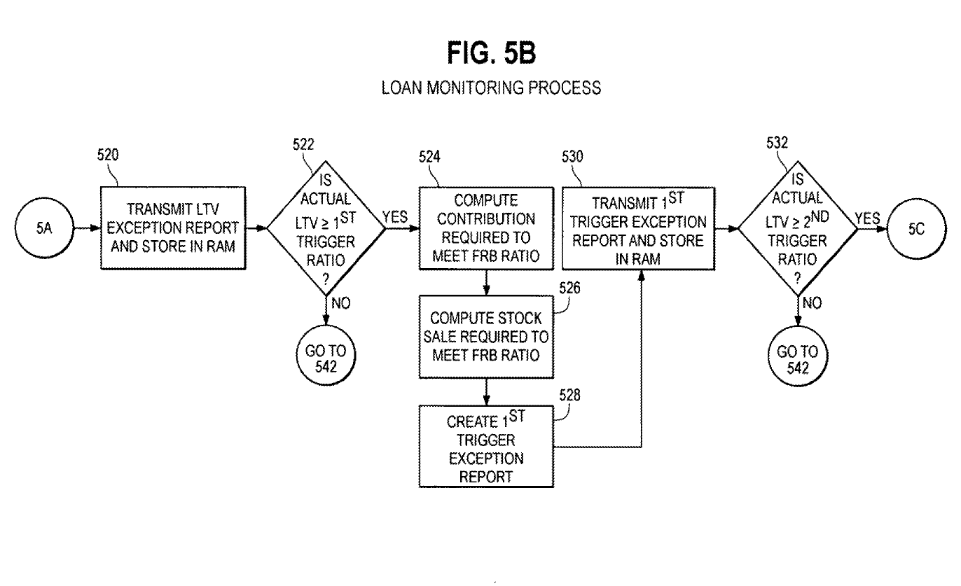

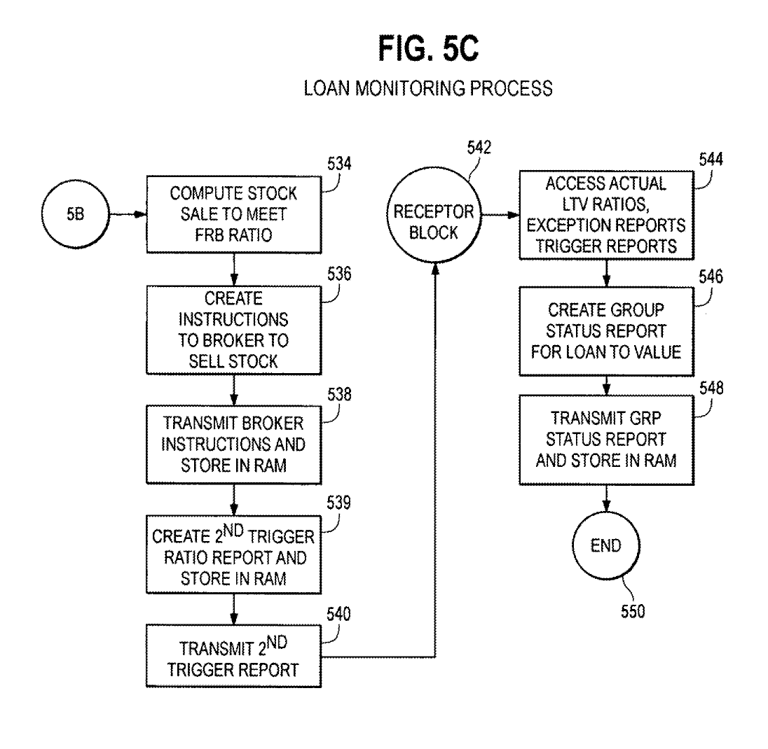

FIG. 5 (collectively FIGS. 5A-5C) is a block diagram of the loan monitoring process 5 of the computer system 100. The steps in the system are designed to provide timely notices of loss of collateral value to the benefit plan parties of interest such as the plan administrator 110, the lender company 112, the plan fiduciary 114, the plan sponsor 116, the plan participant 118, and the brokerage firm 120. Further, the loan monitoring process includes system steps to prevent loans that might violate Reg. U, and system steps to cause an immediate retirement of debt and accrued interest when minimum collateral percentages are breached. This process permits benefit plans to use stock as collateral and not be subject to Reg. T margin calls. Further, the process assures the lender that the non-recourse debt will be retired systematically before the stock collateral becomes less than the loan amount.

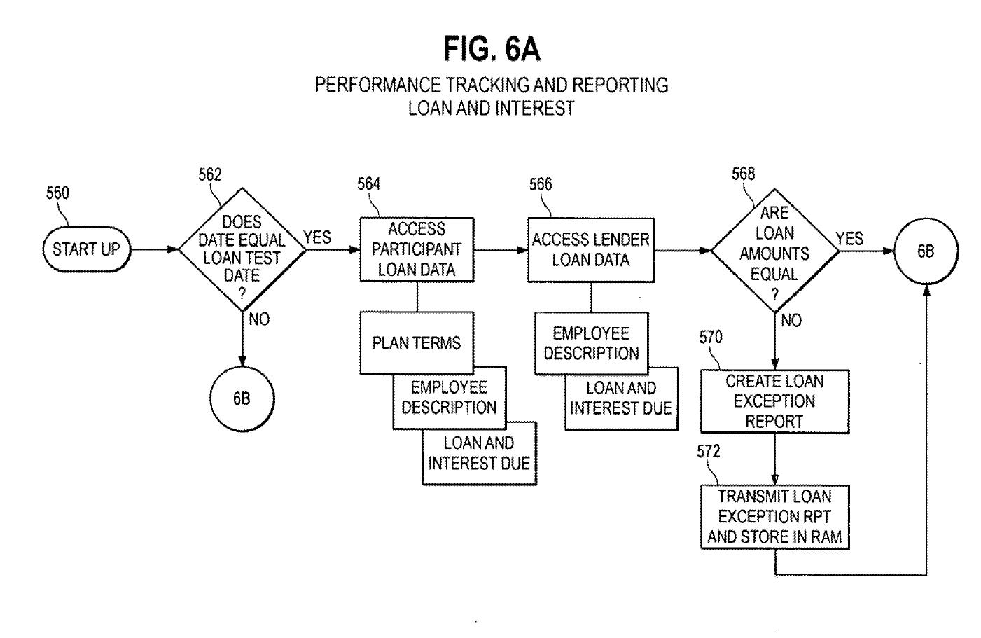

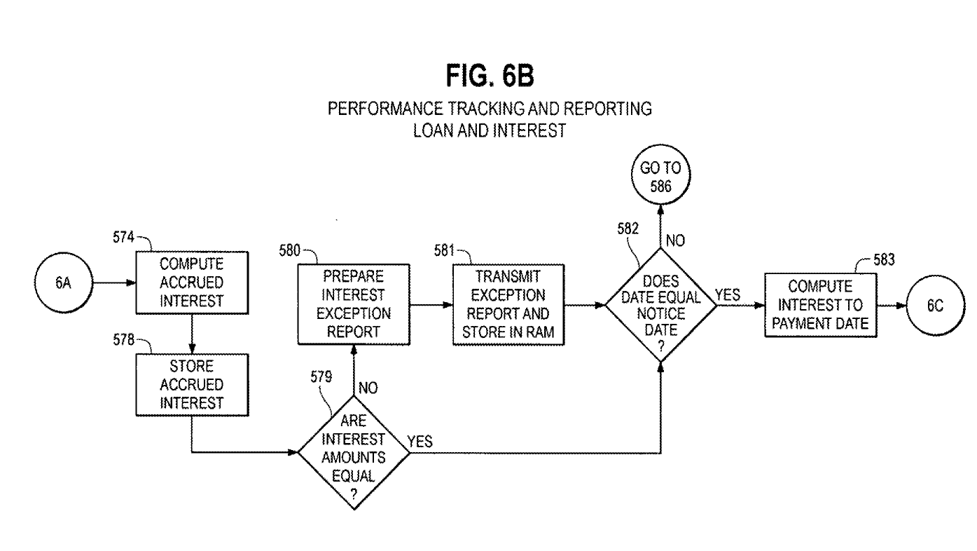

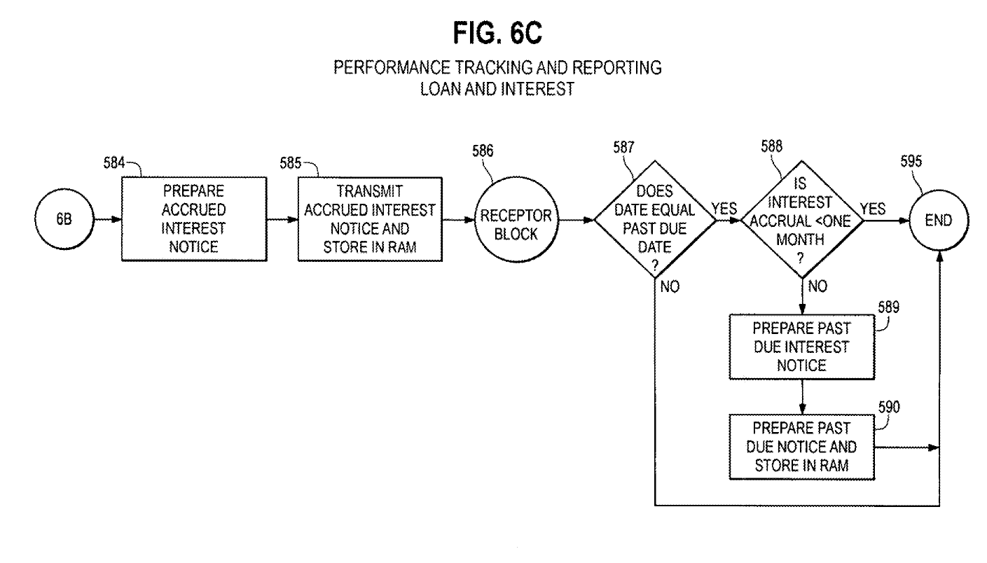

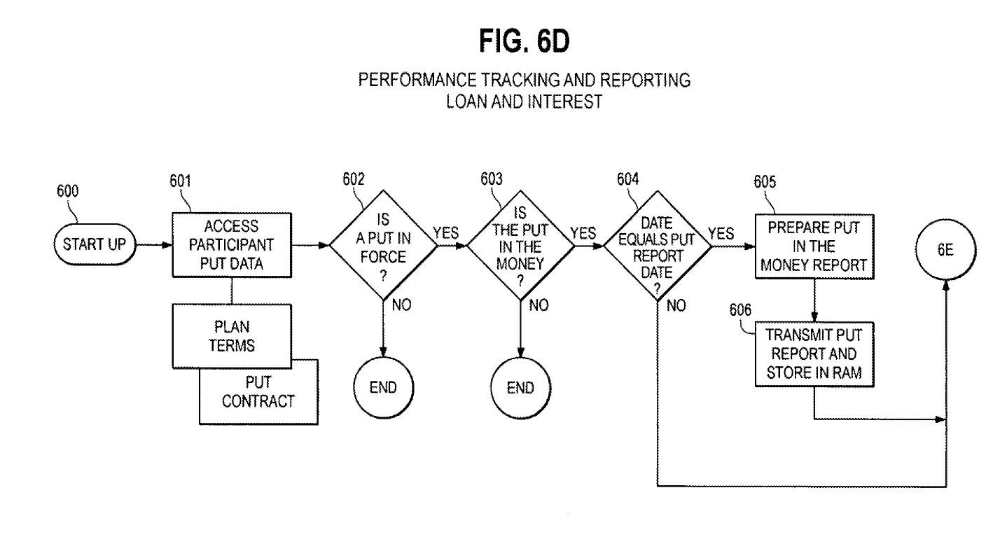

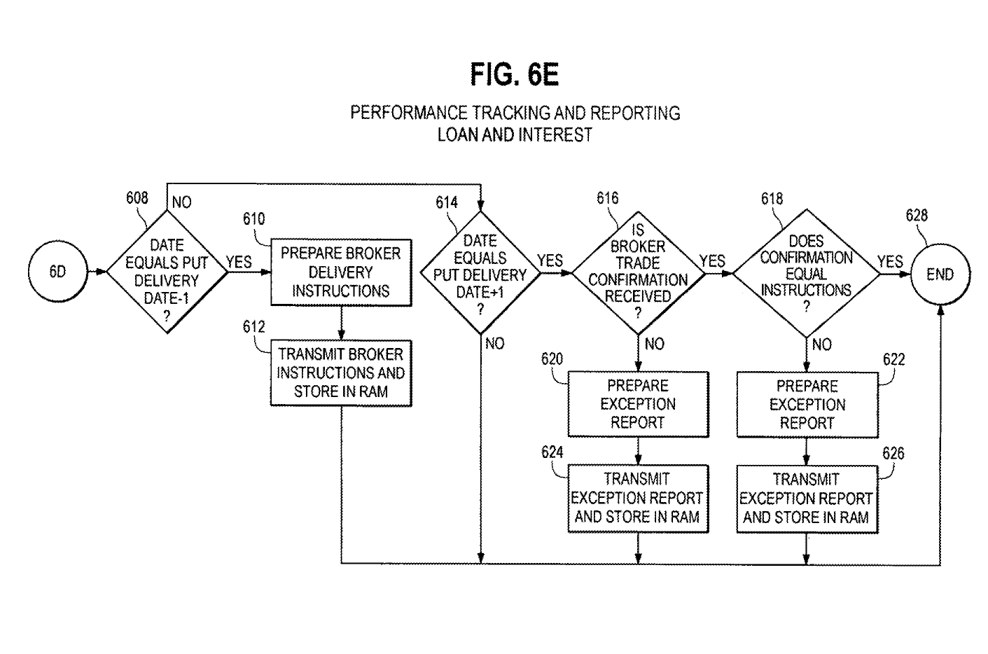

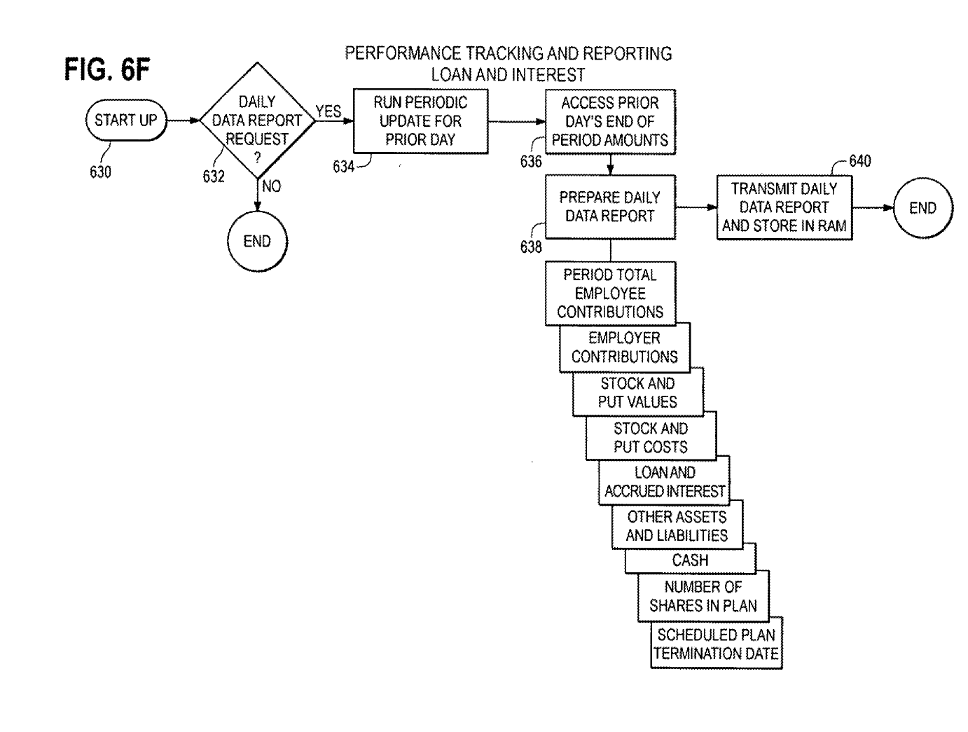

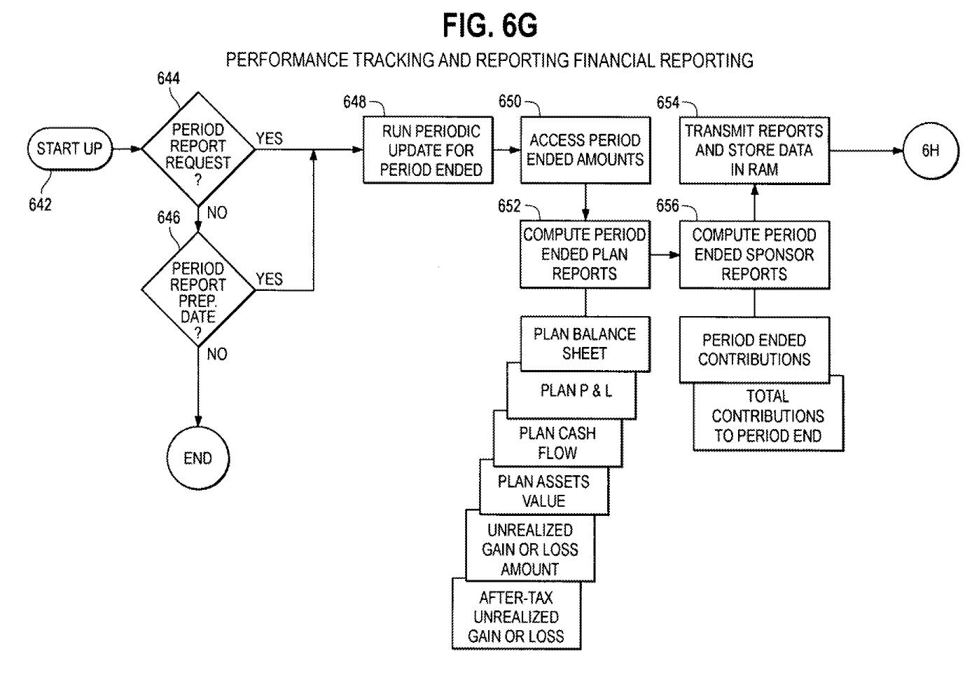

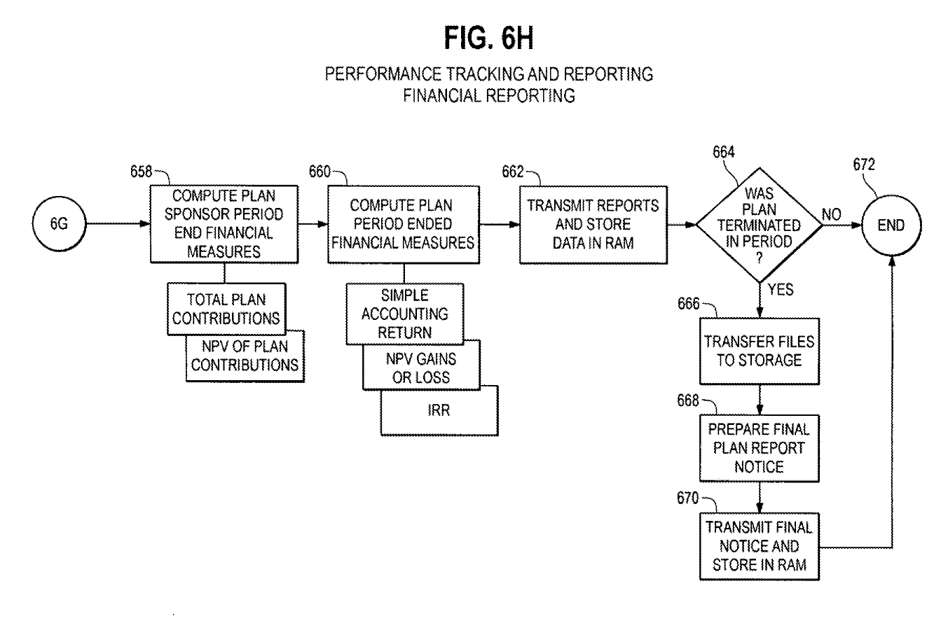

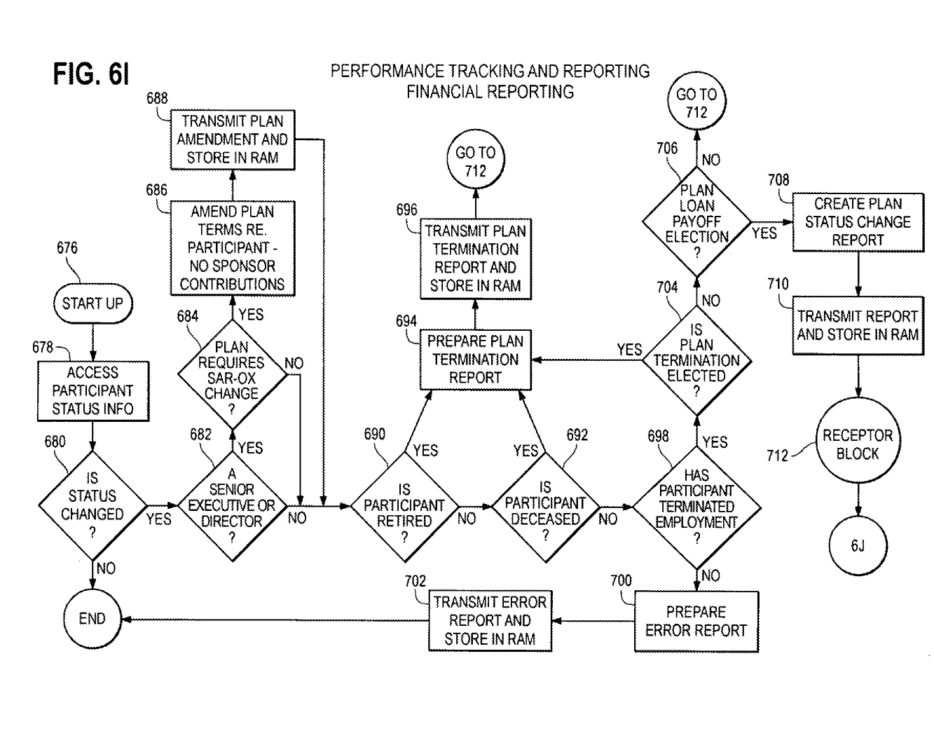

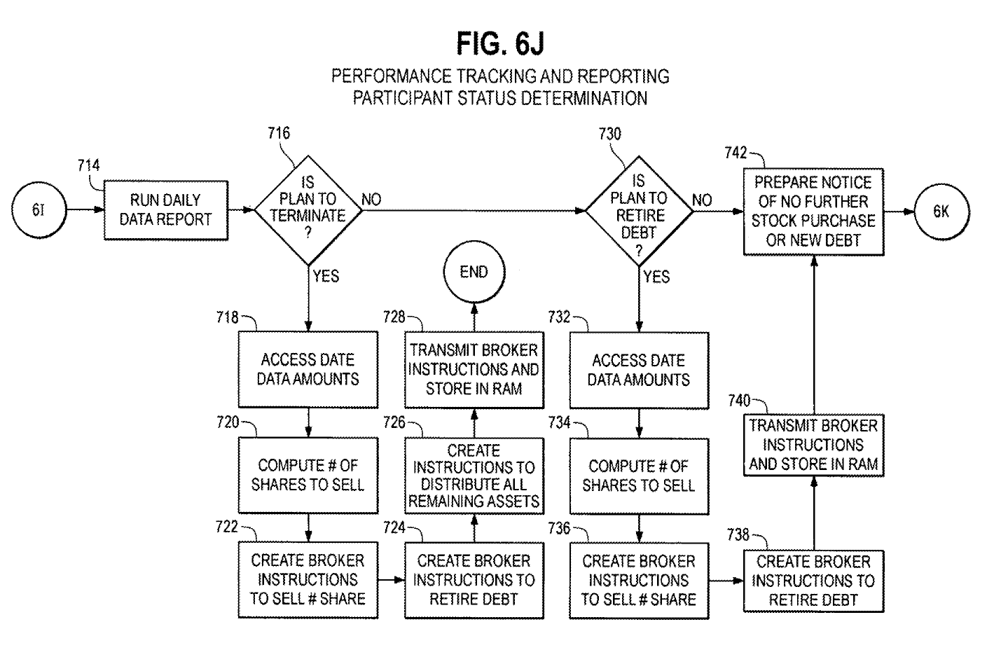

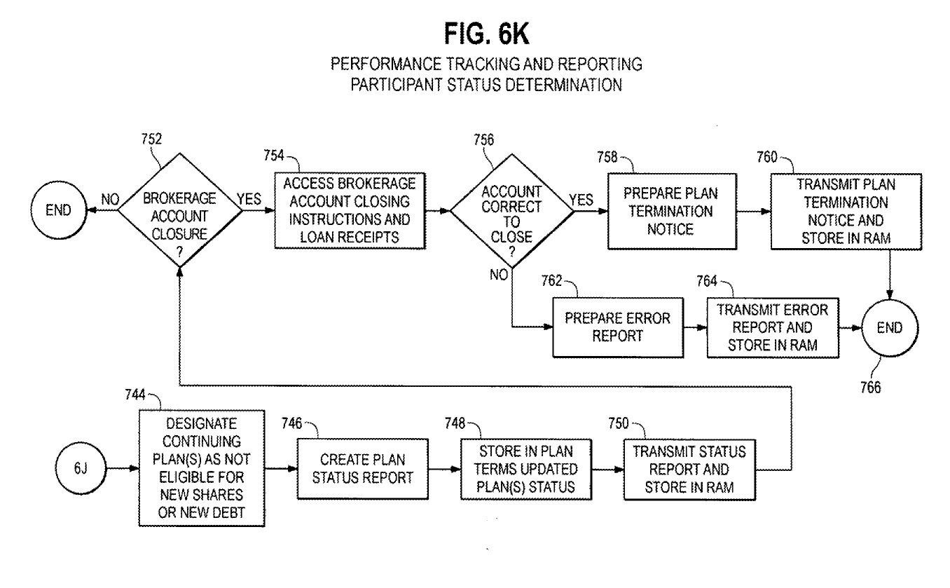

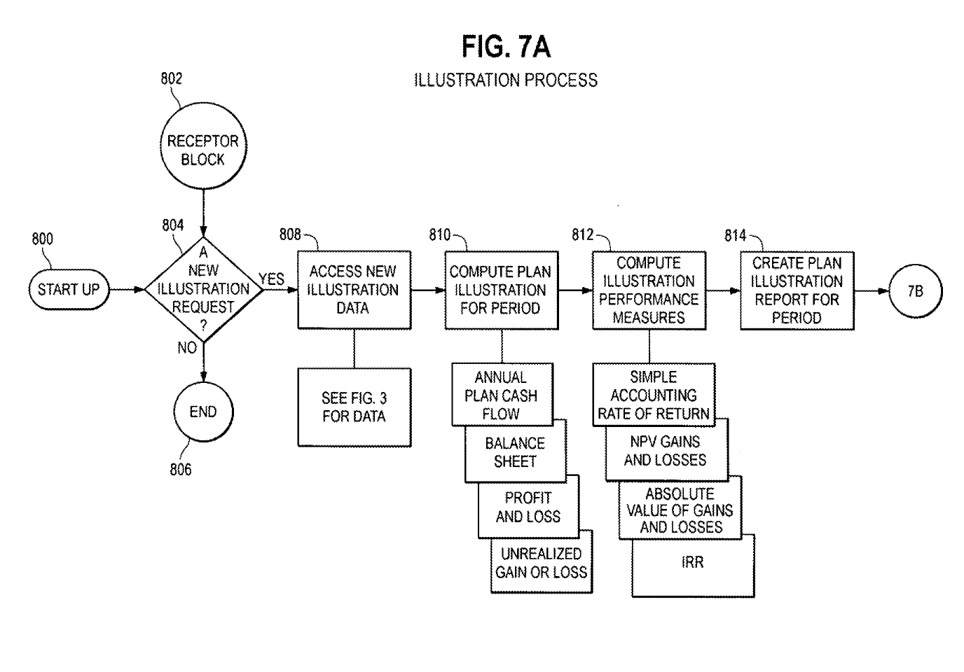

FIG. 6 (collectively FIGS. 6A-6K) is a block diagram of the performance tracking and reporting process 6. The steps of the system are designed to assure that the benefit plan completes its financial obligations on a timely basis and completes timely financial reporting to the respective benefit plan parties of interest. Timely report data is important for each party to manage its aspect of the benefit plan. The report data is generally required for inclusion in compliance reporting with the Internal Revenue Service, the Federal Reserve Bank, and the Depart of Labor (e.g. the preparation of grantor income tax returns by the plan administrator 110 and plan fiduciary 114, the electronic preparation of Forms K-1s for plan participants 118, and Federal Reserve Bank reports for the lender company's Federal Reserve Bank Reg. U compliance report). The electronic preparation and delivery of reports assures low administrative costs making the plan affordable. Further, the dependable exchange and availability of accurate report data assures confidence in the benefit plan.

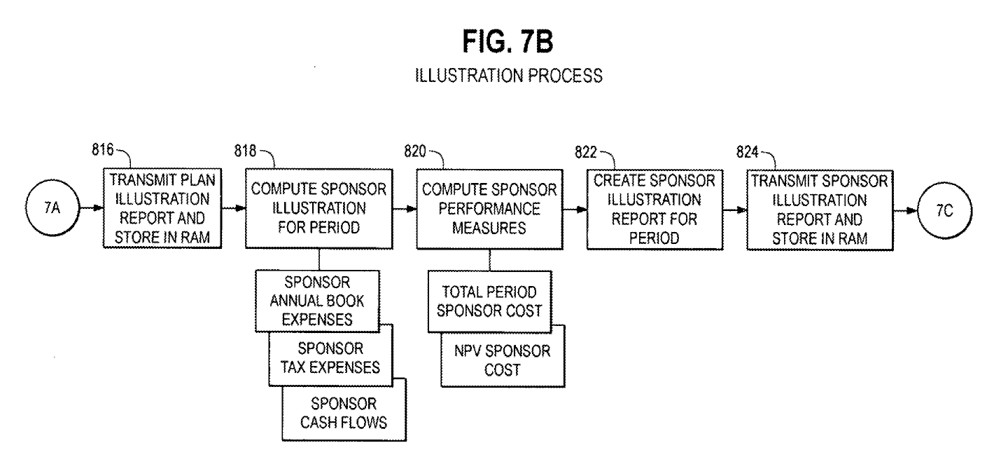

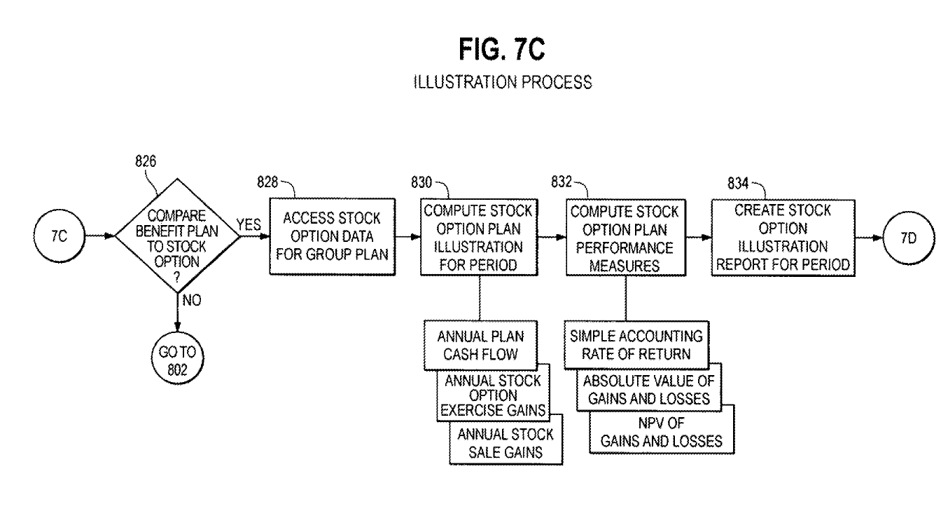

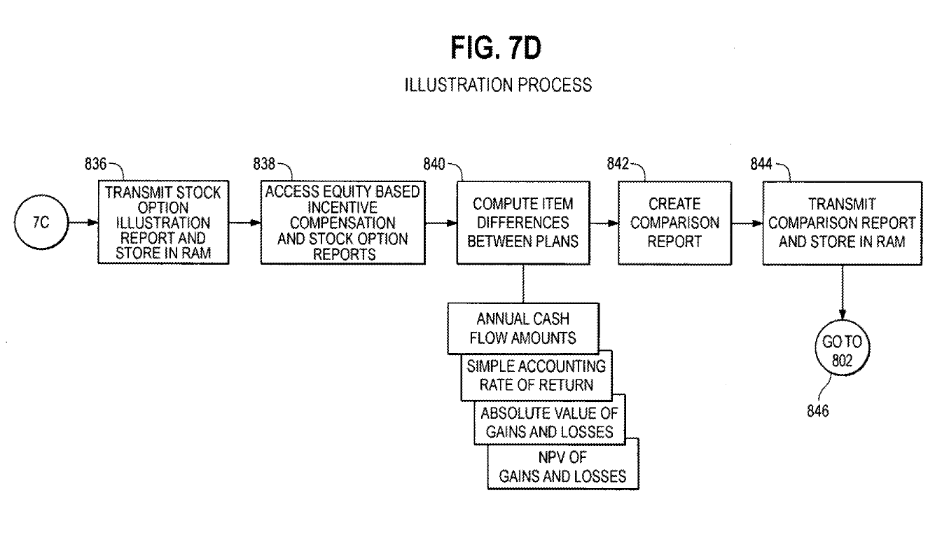

FIG. 7 (collectively FIGS. 7A-7D) is a block diagram of the illustration process 7. This module of the invention takes assumptions about a hypothetical benefit plan and projects the full range of plan financial performance over a user designated period of years. With projected illustrations, a user may assess participant benefits versus sponsor costs, perform sensitivity analysis with respect to different benefit plan variables, prepare cost/benefit analysis regarding the use of puts, and gain a better appreciation of the benefit of a participant paying capital tax versus ordinary income tax on appreciation of stock held in the plan. In addition, the illustration process 7 takes assumptions about a hypothetical nonqualified stock option plan and prepares financial projections of performance similar to those prepared for a benefit plan. Finally the computer system 100 prepares a comparison of periodic cash flows, the group's NPV gains and simple accounting returns as well as the sponsor's total cost, book cost, and NPV of costs.

It is noted that although the figures portray an EBIC plan according to the original embodiment, similar processes are followed with regards to an EBIC plan according to the alternative embodiment. For example, plans according to both embodiments can be established in similar manners using the appropriate information for the specific type of plan (e.g. no puts in the alternative embodiment). Further, plans of both types can be monitored similarly. However, under the alternative embodiment, there is no requirement that the loan be monitored daily because of the employed risk abatement strategies such as forward contracts.

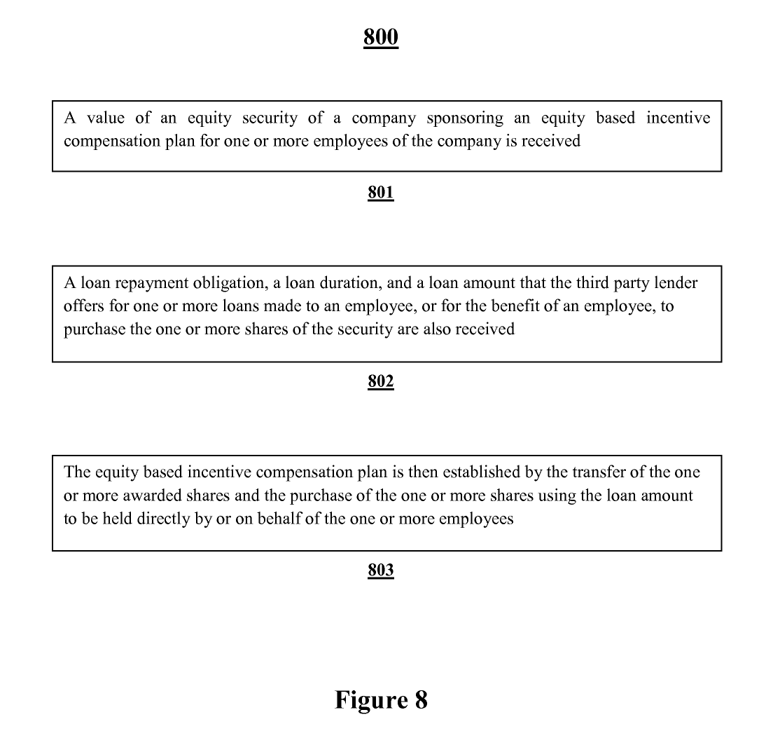

FIG. 8 describes a flowchart of a method 800 for establishing an equity based incentive compensation plan. Method 800 will be described with brief reference to the exemplary computer architecture of FIG. 1. A value of an equity security of a company sponsoring an equity based incentive compensation plan for one or more employees of the company is received (act 801). The equity based incentive compensation plan comprises one or more employees (1) receiving an award grant of one or more shares of the security, or interests therein; and (2) purchasing one or more shares of the security with funds borrowed from a third party lender. For example, computer system 100 may receive the value of the equity security.

A loan repayment amount, a loan duration, and a loan amount that the third party lender offers for one or more loans made to an employee, or for the benefit of an employee, to purchase the one or more shares of the security are also received (act 802). The loan collateral includes, in whole or in part, one or more awarded and purchased shares of the security in the equity based incentive compensation plan. The loan repayment amount less the loan amount comprises interest which reflects the time value of money as well as one or more risk abatement strategies the third party lender may employ based on the lender's assessment of the risk relative to the collateral and the duration of the loan. For example, computer system 100 may receive the loan repayment amount, the loan duration, and the loan amount for each loan from lender computer system 112.

The equity based incentive compensation plan is then established by the receipt of the one or more awarded shares and the purchase of the one or more shares using the loan amount to be held directly by or on behalf of the one or more employees (act 803). For example, computer system 100 may establish (i.e. create and store) the plan.

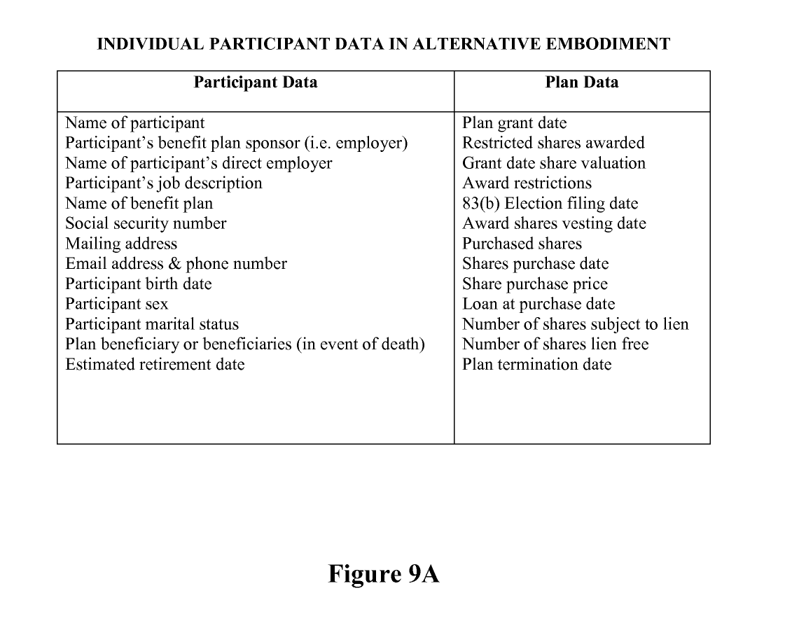

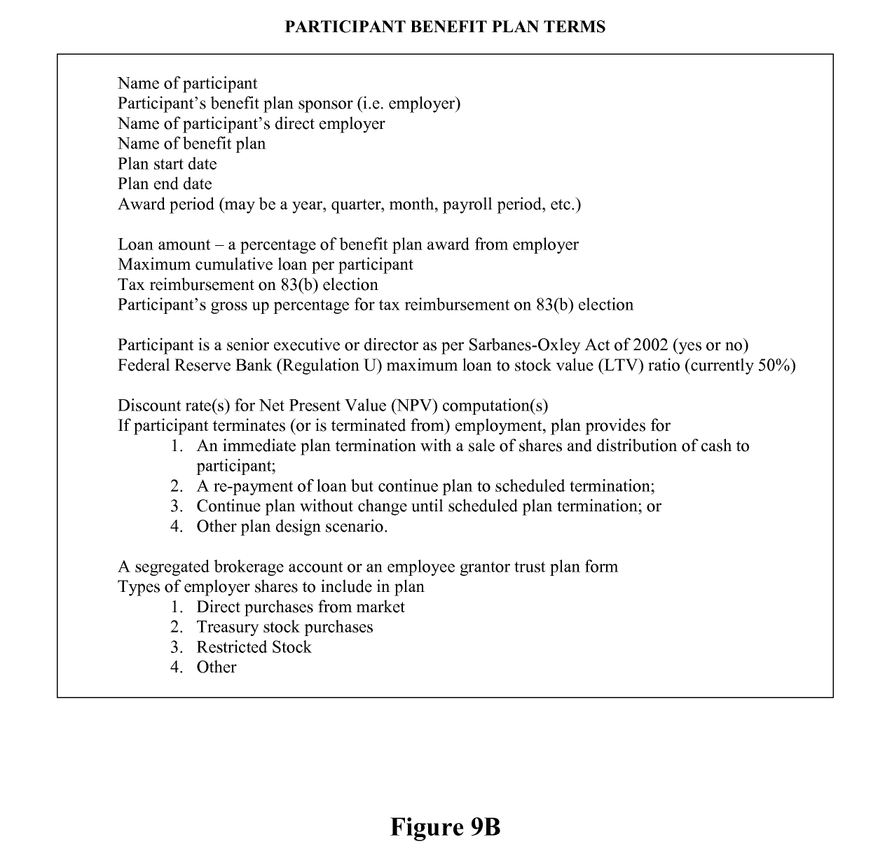

FIGS. 9A-B list various information data fields that may be collected, processed, stored, and/or retrieved by computer system 100 in accordance with the alternative embodiment of the present invention. The invention, however, does not require each of the information fields when establishing a plan.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, implemented by one or more computers, for establishing an equity based incentive compensation plan, comprising:
receiving, at the one or more computers, a value of an equity security of a company sponsoring an equity based incentive compensation plan for one or more employees of the company, wherein the equity based incentive compensation plan comprises one or more employees (1) receiving an award grant of one or more shares of the security, or interests therein; and (2) purchasing one or more shares of the security with funds borrowed from a third party lender;
receiving, at the one or more computers, a loan repayment amount, a loan duration, and a loan amount that the third party lender offers for one or more loans made to an employee, or for the benefit of an employee, to purchase the one or more shares of the security, wherein the loan collateral includes in whole or in part, one or more awarded and purchased shares of the security in the equity based incentive compensation plan, and wherein the loan repayment amount less the loan amount comprises interest which reflects the time value of money as well as one or more risk abatement strategies the third party lender may employ based on the lender's assessment of the risk relative to the collateral and the duration of the loan; and
establishing, at the one or more computers, the equity based incentive compensation plan by the receipt of the one or more awarded shares and the purchase of the one or more shares using the loan amount to be held directly by or on behalf of the one or more employees.

2. The method of claim 1, further comprising:
calculating the ratio of at least a portion of the loan repayment amount divided by the value of the collateralized shares.

3. The method of claim 2 wherein the at least a portion of the loan repayment amount includes the principal of the loan repayment amount and the accrued interest at the time the ratio is calculated.

4. The method of claim 2, further comprising:
preparing one or more reports indicating the ratio.

5. The method of claim 4, further comprising:
sending the one or more reports to one or more of the third party lender, the employer, the employee, an administer of the equity based incentive compensation plan, a brokerage firm with a segregated brokerage account or an employee grantor trust that holds the shares and the obligation to repay the loan repayment amount of the equity based incentive compensation plan.

6. The method of claim 1, wherein the loan duration is fixed.

7. The method of claim 1, wherein the loan repayment amount is due on or before termination of the equity based incentive compensation plan.

8. The method of claim 7, wherein the one or more loans comprise multiple loans including at least two loans that have different loan durations.

9. The method of claim 1, wherein the one or more risk abatement strategies include a forward contract comprising:
a contract between the lender and a counter-party that pays the lender for at least some of the shares of the plan that are delivered to the lender in satisfaction of the loan repayment amount.

10. The method of claim 9 wherein the forward contract between the lender and the counter-party includes one or more collars, puts, or calls.

11. A system comprising one or more computers having one or more processors which execute computer executable instructions to implement the method of claim 1.

12. A method, implemented by one or more computers, for establishing an equity based incentive compensation plan, comprising:
receiving, at the one or more computers, a value of an equity security of a company sponsoring an equity based incentive compensation plan for one or more employees of the company, wherein the equity based incentive compensation plan comprises one or more employees (1) receiving an award grant of one or more shares of the security, or interests therein; and (2) purchasing one or more shares of the security with funds borrowed from a third party lender;
receiving, at the one or more computers, a loan repayment amount, a loan duration, and a loan amount that the third party lender offers for one or more loans made to an employee, or for the benefit of an employee, to purchase the one or more shares of the security, wherein the loan collateral includes at least some of the one or more awarded and purchased shares of the security in the equity based incentive compensation plan;
establishing, at the one or more computers, the equity based incentive compensation plan by the receipt of the one or more awarded shares and the purchase of the one or more shares using the loan amount to be held directly by or on behalf of the one or more employees;
calculating the ratio of at least a portion of the loan repayment amount divided by the value of the collateralized shares; and
notifying one or more of the third party lender, the employer, or the employee of the ratio.

13. The method of claim 12, further comprising:
determining that the ratio is less than or equal to 50%;
receiving an additional loan repayment obligation, an additional loan duration, and an additional loan amount that the third party lender offers for one or more additional loans made to an employee, or for the benefit of an employee, to purchase one or more additional shares of the security, wherein the sum of the loan amount of the one or more loans and the one or more additional loans divided by the sum of the collateralized shares and the one or more additional shares to be purchased with the one or more additional loans is less than or equal to 50%.

14. The method of claim 12 wherein the plan includes a defined ratio that is not 50%, the method further comprising:
determining that the ratio is less than or equal to the defined ratio;
receiving an additional loan repayment amount, an additional loan duration, and an additional loan amount that the third party lender offers for one or more additional loans made to an employee, or for the benefit of an employee, to purchase one or more additional shares of the security, wherein the sum of the loan amount of the one or more loans and the one or more additional loans divided by the sum of the collateralized shares and the one or more additional shares to be purchased with the one or more additional loans is less than or equal to defined ratio.

15. The method of claim 12, further comprising:
notifying one or more of an administer of the equity based incentive compensation plan, a brokerage firm with a segregated brokerage account, or a fiduciary of an employee grantor trust that hold the shares and the obligation to repay the loan repayment amount of the equity based incentive compensation plan of the ratio.

16. A system comprising one or more computers having one or more processors which execute computer executable instructions to implement the method of claim 12.

17. A method, implemented by one or more computers, for modeling a hypothetical equity based incentive compensation plan, comprising:
receiving, at the one or more computers, input comprising:
a value of a share of at least one equity security of a company;
a number of shares of the at least one equity security to be received from an employer award;
an array of hypothetical share values at one or more future points in time;
an amount of funds available to purchase shares of the at least one equity security, wherein a portion of the funds include loan funds from one or more loans;
a loan duration for each of the one or more loans; and
loan repayment amount terms for each of the one or more loans;
generating a model of the hypothetical equity based incentive compensation plan using the input, including:
calculating the number of shares of the at least one equity security that can be acquired using the amount of funds;
calculating the loan repayment amount for each of the one or more loans; and
calculating the value of the hypothetical equity based incentive compensation plan at the one or more future points in times, wherein the value comprises the hypothetical share value of the acquired shares less the sum of the loan repayment amount for each of the one or more loans at the one or more future points in time; and
displaying the model of the hypothetical equity based incentive compensation plan to an end user including displaying for the one or more points in time:
(1) the number of shares that can be acquired using the amount of the funds and the number of shares acquired from the employer award; and
(2) the value of the hypothetical equity based incentive compensation plan.

18. The method of claim 17, further comprising:
receiving, at the one or more computers, a participant's hypothetical ordinary and capital gains income tax rates; and
generating the participant's after-tax cash flows from the hypothetical equity based incentive compensation plan at the one or more future points in time.

19. The method of claim 18, further comprising:
calculating the value of a hypothetical nonqualified stock option plan at the one or more future points in time, wherein the value comprises the fair market value of the number of shares of the at least one equity security to be received from the employer award; and
generating the participant's after-tax cash flows from the hypothetical nonqualified stock option plan at the one or more future points in time.

20. The method of claim 19, further comprising:
displaying a comparison of the hypothetical equity based incentive compensation plan to the hypothetical nonqualified stock option plan at the one or more future points in time including displaying a comparison of one or more of the values or the participant's after-tax cash flows at the one or more future points in time under the two plans.

21. The method of claim 17, further comprising:
receiving, at the one or more computers, the employer's hypothetical income tax rates; and
generating the employer's after-tax cash flows and GAAP expenses at the one or more future points in time.

22. The method of claim 21, further comprising:
generating the employer's after-tax cash flows and GAAP expenses at the one or more future points in time under a hypothetical nonqualified stock option plan.

23. The method of claim 22, further comprising:
displaying a comparison of the hypothetical equity based incentive compensation plan to the hypothetical nonqualified stock option plan at the one or more future points in time including displaying a comparison of the employer's after-tax cash flows and GAAP expenses under the two plans.

24. The method of claim 18, further comprising:
calculating the value of a hypothetical restricted stock award plan at the one or more future points in time, wherein the value comprises the fair market value of the number of shares of the at least one equity security to be received from the employer award; and
generating the participant's after-tax cash flows from the hypothetical restricted stock award plan at the one or more future points in time.

25. The method of claim 24, further comprising:
displaying a comparison of the hypothetical equity based incentive compensation plan to the hypothetical restricted stock award plan at the one or more future points in time including displaying a comparison of one or more of the values or the participant's after-tax cash flows at the one or more future points in time under the two plans.

26. The method of claim 21, further comprising:
generating the employer's after-tax cash flows and GAAP expenses at the one or more future points in time under a hypothetical restricted stock award plan.

27. The method of claim 22, further comprising:
displaying a comparison of the hypothetical equity based incentive compensation plan to the hypothetical restricted stock award plan at the one or more future points in time including displaying a comparison of the employer's after-tax cash flows and GAAP expenses under the two plans.

28. A system comprising one or more computers having one or more processors which execute computer executable instructions to implement the method of claim 17.
